(19) United States
(12) Patent Application Publication
(10) Pub. No.: US 2026/0367609 A1
(43) Pub. Date: Nov. 19, 2026

(54) METHODS AND APPARATUS TO PRESENT SIGNATURE DATA, CALIBRATION DATA, AND/OR TESTING DATA USING A WEBSERVER IN A DIGITAL CONTROLLER

(71) Applicant: Fisher Controls International LLC, Marshalltown, IA (US)

(72) Inventor: Jared Vance Korthuis, Corvallis, OR (US)

(21) Appl. No.: 19/673,616

(22) Filed: May 11, 2026

Related U.S. Application Data
(60) Provisional application No. 63/807,383, filed on May 16, 2025.

(51) Int. Cl. G05B 19/416

(52) U.S. Cl. CPC G05B 19/416; G05B 2219/37371

(57) ABSTRACT

Systems, apparatus, articles of manufacture, and methods to present signature data, calibration data, and/or testing data using a webserver in a digital controller are disclosed. An example apparatus includes programmable circuitry to: instantiate a webserver at a field device in a control system; establish a connection between the webserver and a client device; cause the field device to perform a procedure; collect data associated with performance of the procedure; and cause interface circuitry to transmit the data from the webserver to the client device in substantially real-time to when the data is collected.

### RELATED APPLICATIONS

This patent claims the benefit of U.S. Provisional Pat. App. No. 63/807,383, which is entitled “DIGITAL FIELD DEVICE CONTROLLERS WITH WEBSERVERS AND METHODS THEREOF,” and was filed on May 16, 2025. U.S. Provisional Pat. App. No. 63/807,383 is incorporated herein by reference in its entirety. Priority to U.S. Provisional Pat. App. No. 63/807,383 is claimed.

### FIELD OF THE DISCLOSURE

This disclosure relates generally to distributed control systems and, more particularly, to methods and apparatus to present signature data, calibration data, and/or testing data using a webserver in a digital controller.

### BACKGROUND

Control valves (e.g., sliding stem valves, rotary valves, axial flow valves, globe valves, etc.) are commonly used in industrial processes, such as oil and gas pipeline distribution systems and chemical processing plants, to control the flow of process fluids. These control valves are often automated using an actuator that is controlled by a field device (e.g., a digital valve controller). Such field devices typically communicate with a process control computer to command fluid flow changes within the valve to achieve a desired control strategy.

### SUMMARY

An example apparatus includes: interface circuitry; machine-readable instructions; programmable circuitry to be programmed by the machine-readable instructions to: instantiate a webserver at a field device in a control system; establish a connection between the webserver and a client device; cause the field device to perform a procedure; collect data associated with performance of the procedure; and cause the interface circuitry to transmit the data from the webserver to the client device in substantially real-time to when the data is collected.

An example non-transitory machine-readable medium comprising instructions to cause programmable circuitry to at least: interface circuitry; machine-readable instructions; programmable circuitry to be programmed by the machine-readable instructions to: instantiate a webserver at a field device in a control system; establish a connection between the webserver and a client device; cause the field device to perform a procedure; collect data associated with performance of the procedure; and cause transmission of the data from the webserver to the client device in substantially real-time to when the data is collected.

An example method includes: instantiating, by executing instructions with programmable circuitry, a webserver at a field device in a control system; establishing a connection between the webserver and a client device; causing the field device to perform a procedure; collecting data associated with performance of the procedure; and transmitting, by executing instructions with programmable circuitry, the data from the webserver to the client device in substantially real-time to when the data is collected.

### BRIEF DESCRIPTION OF THE DRAWINGS

FIG. 1 is an example environment in which an example digital valve controller includes an example webserver and is in communication with client devices.

FIG. 2 is the example environment of FIG. 1 with multiple example digital valve controllers in communication with client devices.

FIG. 3 is a block diagram of an example implementation of the digital valve controller of FIG. 1.

FIG. 4 is an example device overview graphical user interface (GUI) that may be served by the webserver in the digital valve controller of FIGS. 1 and 3 to configure and/or display process variables.

FIG. 5 is an example trends GUI that may be served by the webserver in the digital valve controller of FIGS. 1 and 3 to display process variables.

FIG. 6 is an example setup overview GUI that may be served by the webserver in the digital valve controller of FIGS. 1 and 3 to display and/or configure device settings.

FIG. 7 is an example communications settings GUI that may be served by the webserver in the digital valve controller of FIGS. 1 and 3 to display and/or configure device communication settings.

FIG. 8 is an example alert setup GUI that may be served by the webserver in the digital valve controller of FIGS. 1 and 3 to display and/or configure device alert settings.

FIG. 9 is an example active alerts GUI that may be served by the webserver in the digital valve controller of FIGS. 1 and 3 to display active diagnostic alerts.

FIG. 10 is an example video tutorial GUI that may be served by the webserver in the digital valve controller of FIGS. 1 and 3 to troubleshoot active diagnostic alerts.

FIG. 11 is an example valve signature total scan GUI that may be served by the webserver in the digital valve controller of FIGS. 1 and 3 to display diagnostic valve signatures.

FIG. 12 is an example tuning GUI that may be served by the webserver in the digital valve controller of FIGS. 1 and 3 to perform tuning maintenance.

FIG. 13 is an example calibrate pressure sensors GUI that may be served by the webserver in the digital valve controller of FIGS. 1 and 3 to perform calibration maintenance.

FIGS. 14 and 15 show an example camera view of device GUI that may be served by the webserver in the digital valve controller of FIGS. 1 and 3 to perform connectivity maintenance.

FIG. 16 shows an example camera view of device vicinity GUI that may be served by the webserver in the digital valve controller of FIGS. 1 and 3 to provide a visual indication of conditions in an area proximate to the digital valve controller.

FIG. 17 is a block diagram of an example system to enable the client device to access the webserver of the digital valve controller and also access large files from one or more web browser extension(s).

FIG. 18 is an example operations sequence 1800 involving interactions between the client device and the digital valve controller of FIG. 17.

FIGS. 19 and 20 are flowcharts representative of example machine-readable instructions and/or example operations that may be executed, instantiated, and/or performed by example programmable circuitry to implement the digital valve controllers and webservers of FIGS. 1-3.

FIG. 21 is a block diagram of an example processing platform including programmable circuitry structured to execute, instantiate, and/or perform the example machine-readable instructions and/or perform the example operations of FIGS. 19 and 20 to implement the digital valve controllers and webservers of FIGS. 1-3.

FIG. 22 is a block diagram of an example software/firmware/instructions distribution platform (e.g., one or more servers) to distribute software, instructions, and/or firmware (e.g., corresponding to the example machine-readable instructions of FIGS. 19 and 20) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Examples disclosed herein may be used to implement digital field device controllers having integrated webservers and associated methods. Example webservers integrated into field device controllers, as disclosed herein, are designed to display device-specific data through a streamlined, browser-accessible interface. Examples disclosed herein may be implemented using Ethernet with an Advanced Physical Layer (Ethernet-APL) for monitoring, configuring, and interacting with field device controllers across a process control system. Examples disclosed herein provide intuitive methods to access diagnostics, configuration information, and substantially real-time data directly from the field device controllers. Examples disclosed herein enhance accessibility of the integrated webservers, modernize user experience, and accelerate field workflows. In examples disclosed herein, example field device controllers with integrated webservers are described as digital valve controllers (e.g., valve positioners). However, examples disclosed herein may be implemented in connection with any other type of field device controller (e.g., a flow meter, etc.).

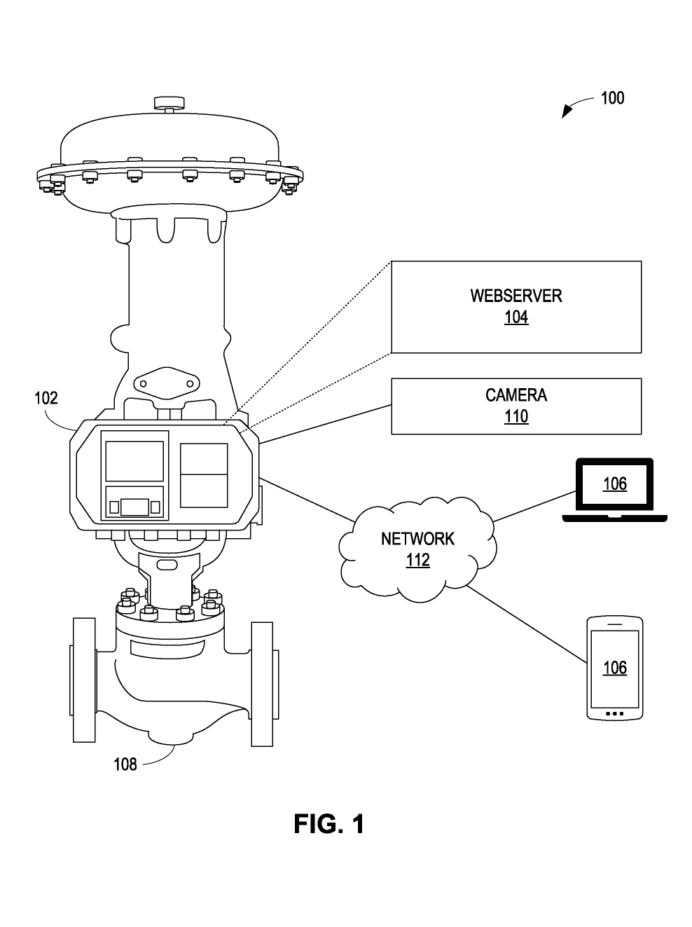

FIG. 1 is an example environment 100 in which an example digital valve controller 102 includes an integrated example webserver 104 and is in communication with client devices 106. The digital valve controller 102 is operatively coupled to a fluid control valve 108 to configure, control, and monitor operations of the fluid control valve 108. In some examples, the digital valve controller 102 is operatively coupled to a camera 110 (e.g., a webcam) positioned with a view capturing the digital valve controller 102, the fluid control valve 108, and/or an area adjacent to (e.g., in the vicinity of) the digital valve controller 102. The digital valve controller 102 is in communication with the client devices 106 via an example network 112 such as a local area network (LAN) or a wide area network (WAN) (e.g., the Internet). Although examples disclosed herein are described in connection with the fluid control valve 108, examples disclosed herein may be implemented with any other component of a process control system.

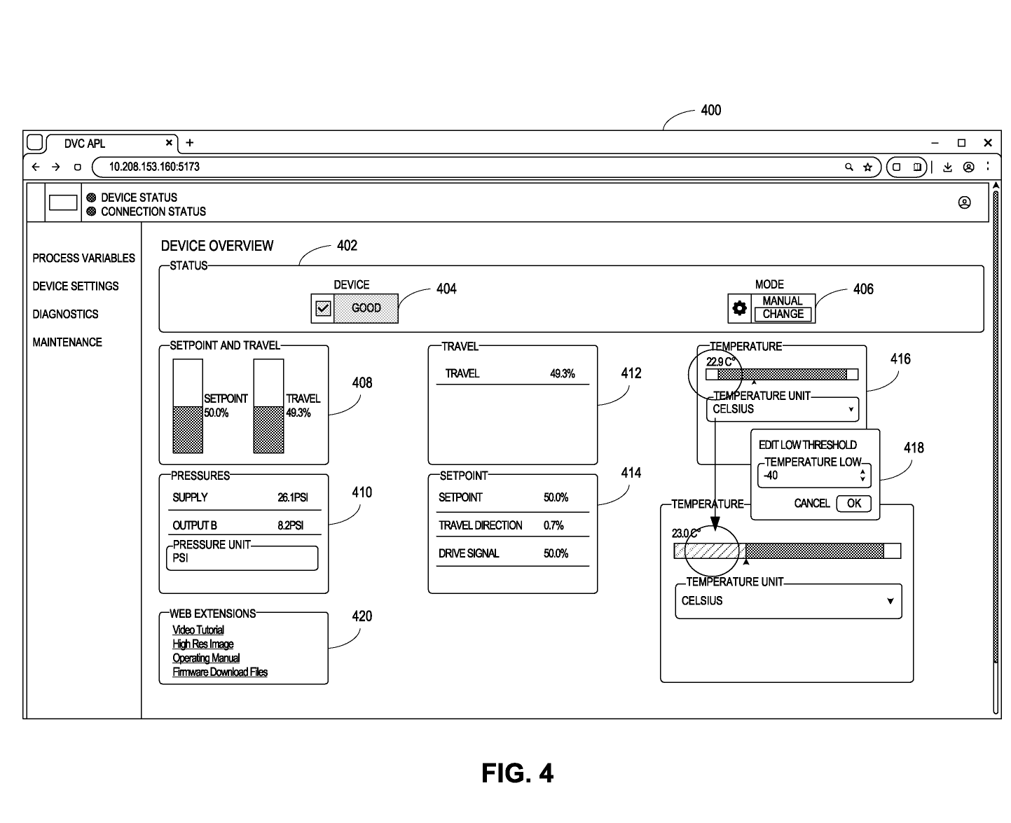

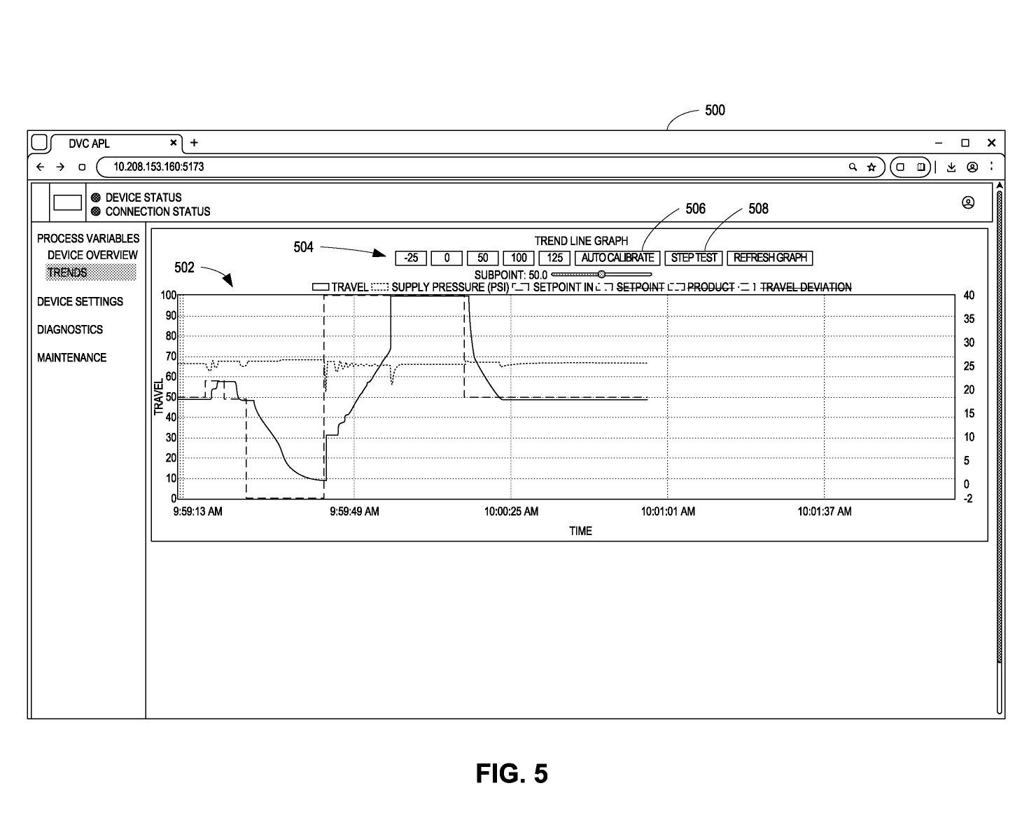

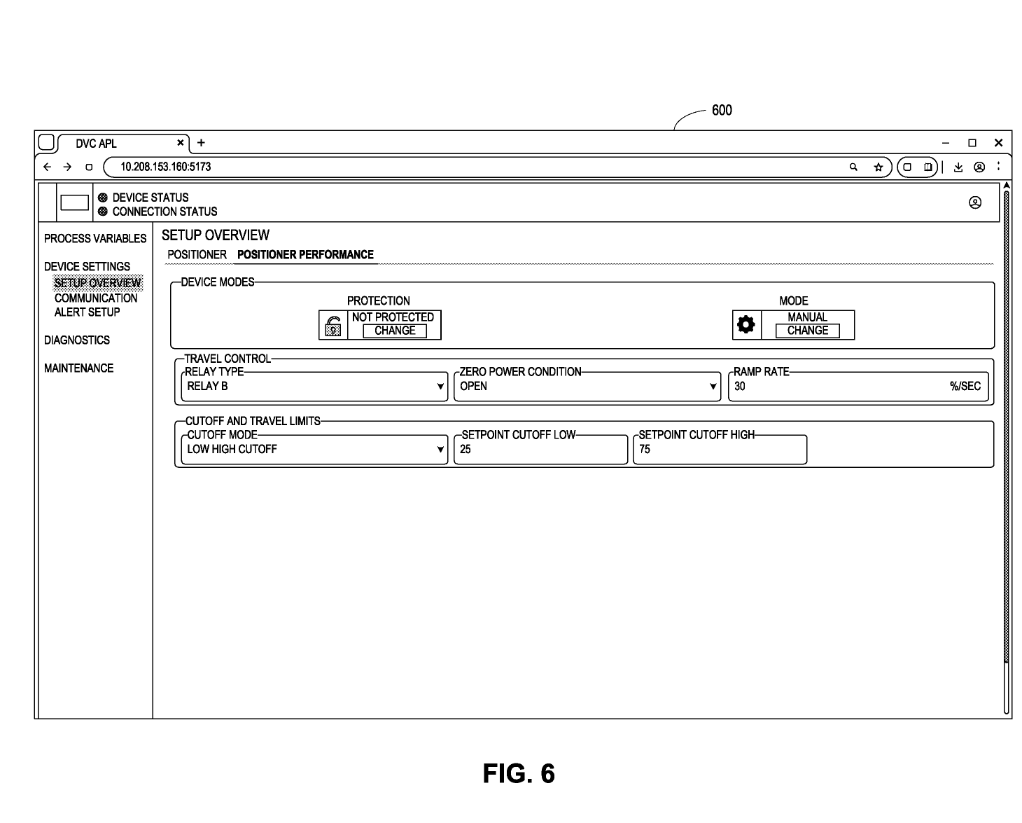

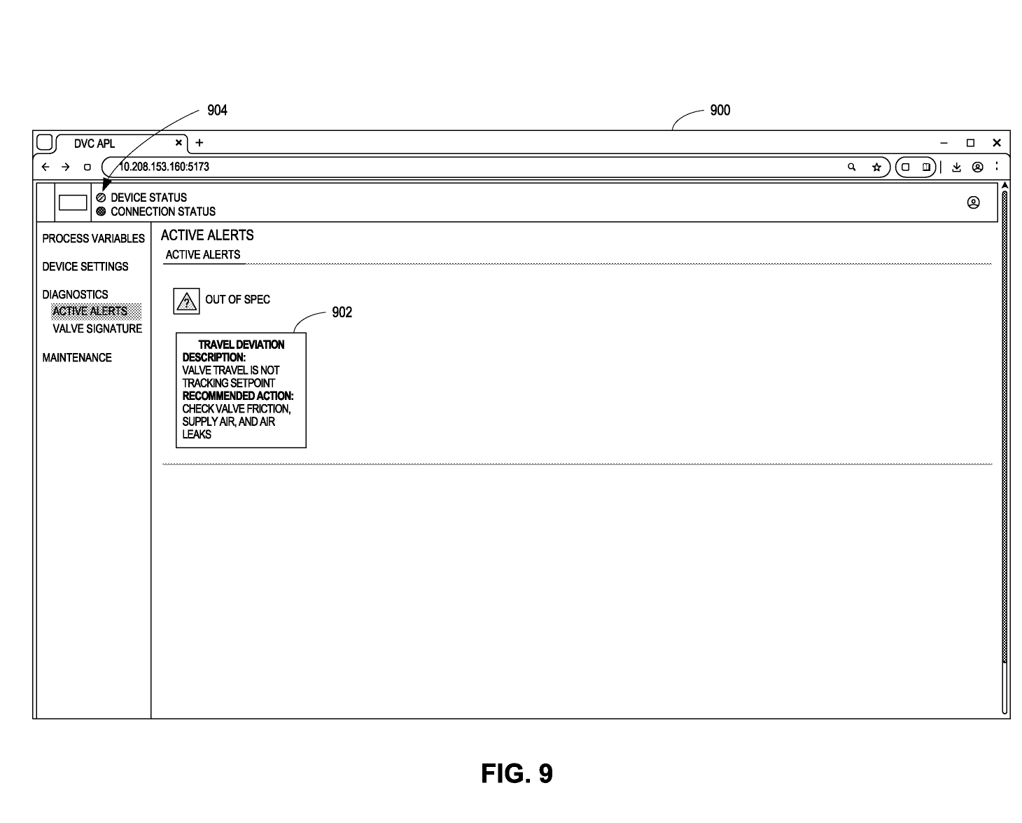

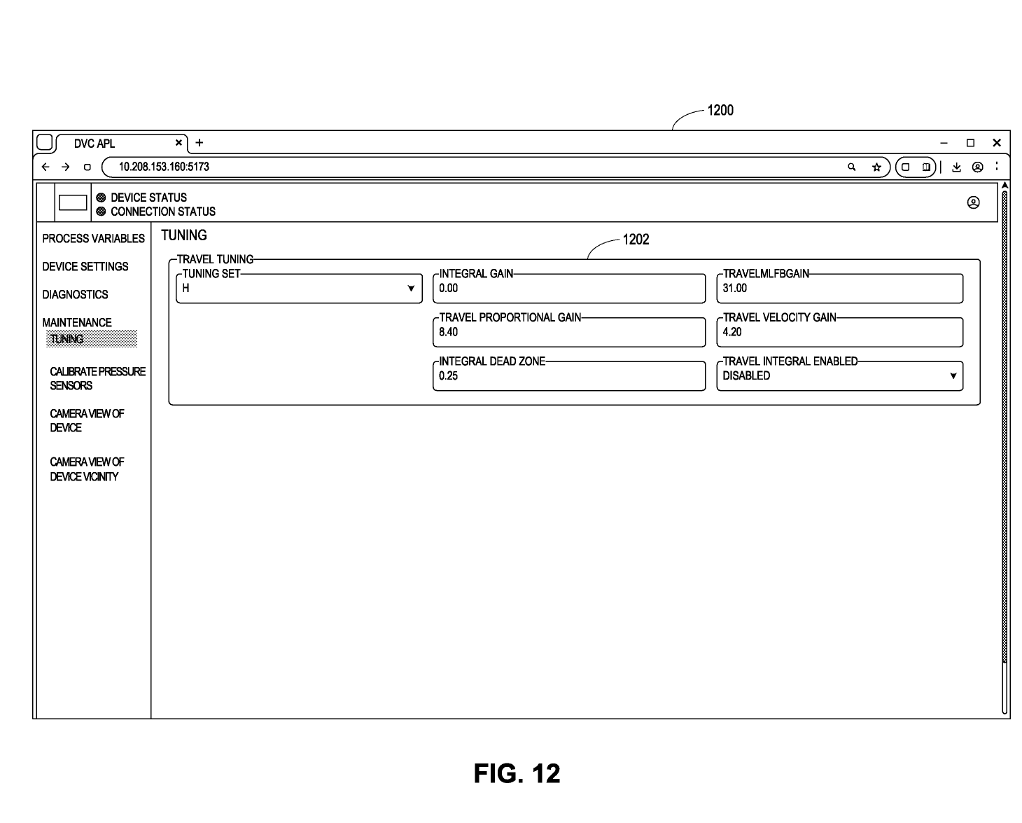

The webserver 104 includes built-in interfaces hosted directly on the digital valve controller 102 and accessible via an internet protocol (IP) address of the digital valve controller 102 through any standard internet web browser and/or app. The webserver 104 provides access to a range of capabilities associated with configuring, controlling, and monitoring the digital valve controller 102 and the fluid control valve 108. Examples of such capabilities include substantially real-time diagnostics (e.g., valve signatures, step test results, device alerts, and alarms), configuration tools (e.g., adjustments of device-specific settings, communication parameters, and alert thresholds), live data visualizations (e.g., substantially real-time insights into travel, supply pressures, setpoint inputs, output pressures, and travel deviations), secure remote access (e.g., accessible from within a plant’s control network — no handheld or local user interface required to be within short wireless communication proximity). Example GUIs served by the webserver 104 are shown in FIGS. 4-16 and include example process variable GUIs in FIGS. 4 and 5, example device setting GUIs in FIGS. 6-8, example diagnostic GUIs in FIGS. 9-11, and example maintenance GUIs in FIGS. 12-16.

In examples disclosed herein, client devices 106 can remotely access the webserver 104 via the network 112 so that users can access status information and interact with the digital valve controller 102 from a convenient and/or safe location regardless of where the digital valve controller 102 is located in a process control system. The client devices 106 are shown as an example laptop/personal computer and a mobile communication device (e.g., a smartphone, a tablet computing device, etc.). However, the client devices 106 may include any other suitable type and/or any other number of devices having an app or web browser to access the webserver 104.

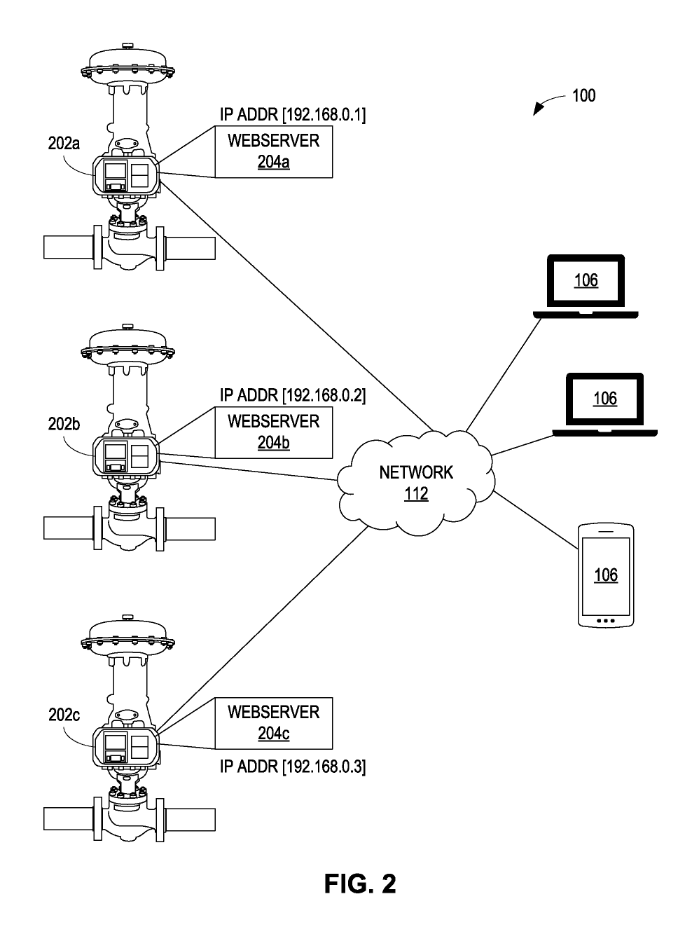

FIG. 2 is the example environment 100 of FIG. 1 with multiple example digital valve controllers 202a-c in communication with the client devices 106. The digital valve controllers 202a-c are substantially similar or identical to the digital valve controller 102 of FIG. 1. In the example of FIG. 2, each of the digital valve controllers 202a-c includes a corresponding webserver 204a-c substantially similar or identical to the webserver 104 of FIG. 1 and each webserver 204a-c is assigned a corresponding, unique IP address. For example, the webserver 204a of the digital valve controller 202a is assigned IP address 192.168.0.1, the webserver 204b of the digital valve controller 202b is assigned IP address 192.168.0.2, and the webserver 204c of the digital valve controller 202c is assigned IP address 192.168.0.3. The client devices 106 can access specific ones of the digital valve controllers 202a-c and the webservers 204a-c based on their corresponding IP addresses. The webservers 204a-c are configured to serve substantially real-time diagnostics data and configuration controls to multiple ones of the client devices 106 simultaneously and allow multiple users to interact with and change configurations via corresponding ones of the client devices 106.

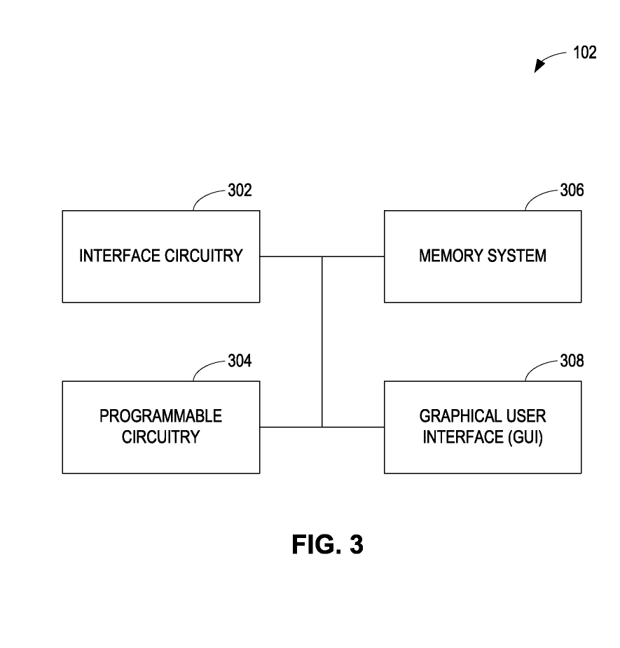

FIG. 3 is a block diagram of an example implementation of the digital valve controller 102 of FIG. 1 to configure, control, and monitor the digital valve controller 102 and the fluid control valve 108 of FIG. 1. The digital valve controller 102 of FIG. 3 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the digital valve controller 102 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured to perform operations of the digital valve controller 102. It should be understood that some or all of the circuitry of FIG. 3 may be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The digital valve controller 102 includes example interface circuitry 302, example programmable circuitry 304, an example memory system 306, and an example graphical user interface (GUI) 308. The interface circuitry 302 is provided to enable the webserver 104 to receive and send communications via the network 112. The programmable circuitry 304 is provided to instantiate the webserver 104. The memory system 306 is provided to store machine-readable instructions to implement the webserver 104 and to store substantially real-time diagnostics data, configuration tools, configuration data, and live data. The memory system 306 may include any suitable type of volatile memory (e.g., random-access memory (RAM)), non-volatile memory (e.g., read-only memory (ROM), flash memory, etc.), and/or storage (e.g., one or more solid-state drives (SSDs), one or more magnetic hard disk drives (HDDs), optical drives, etc.). The GUI 308 provides different screens of the webserver 104 to display substantially real-time diagnostics data, configuration tools, configuration data, and live data for access by users via the client devices 106.

In some examples, the programmable circuitry 304 is programmed by machine-readable instructions to perform operations to implement features described below in connection with FIGS. 4-16.

As described above, the interface circuitry 302, the programmable circuitry 304, the memory system 306, and the GUI 308 of FIG. 3 are structures. Such structures may implement means for performing corresponding disclosed functions. Examples of such functions are described above in connection with corresponding ones of the interface circuitry 302, the programmable circuitry 304, the memory system 306, and the GUI 308 and are described below in connection with FIGS. 4-16.

While an example manner of implementing the digital valve controller 102 of FIG. 1 is illustrated in FIG. 3, one or more of the elements, processes, and/or devices illustrated in FIG. 3 may be combined, divided, re-arranged, omitted, eliminated, and/or implemented in any other way. Further, the interface circuitry 302, the programmable circuitry 304, the memory system 306, and the GUI 308, and/or, more generally, the example digital valve controller 102 of FIG. 3, may be implemented by hardware alone or by hardware in combination with software and/or firmware. Thus, for example, any of the interface circuitry 302, the programmable circuitry 304, the memory system 306, and the GUI 308, and/or, more generally, the example digital valve controller 102, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example digital valve controller 102 of FIG. 3 may include one or more elements, processes, and/or devices in addition to, or instead of, those illustrated in FIG. 3, and/or may include more than one of any or all of the illustrated elements, processes and devices.

FIG. 4 is an example device overview GUI 400 that may be served by the webserver 104 in the digital valve controller 102 of FIGS. 1 and 3 to configure and/or display process variables. The device overview GUI 400 includes an example device status area 402 that includes an example device status indicator 404 and an example mode control element 406. The device status indicator 404 allows users to monitor the status of the digital valve controller 102 and the corresponding fluid control valve 108. The example mode control element 406 shows a current operating mode of the digital valve controller 102 and allows users to change the mode between auto and manual modes.

The device overview GUI 400 includes different process variable widgets to show substantially real-time updates of process variables of the digital valve controller 102 and/or the corresponding fluid control valve 108. The widgets can show the process variables in different formats (e.g., charts, lists, etc.). The device overview GUI 400 includes an example setpoint and travel widget 408 that displays a configured travel setpoint relative to an actual travel of a plunger of the fluid control valve 108. As used herein, a plunger is an internal component of a fluid control valve that is stroked towards a closed position to decrease fluid flow through the fluid control valve by decreasing the size of an opening of the fluid control valve. The plunger is also stroked in an opposite direction towards an open position to increase fluid flow through the fluid control valve by increasing the size of the opening of the fluid control valve.

The device overview GUI 400 includes an example pressures widget 410 that displays pressure measurements associated with the controller input and outputs (e.g., input supply pressure and output pressure for port A and port B). The device overview GUI 400 includes an example travel widget 412 that shows the actual travel of the plunger of the fluid control valve 108. The device overview GUI 400 includes an example setpoint widget 414 that shows the configured travel setpoint, a travel distance, and a device signal associated with operating the plunger of the fluid control valve 108. The device overview GUI 400 includes an example temperature widget 416 that shows a temperature measurement associated with the digital valve controller 102.

The pressures widget 410 and the temperature widget 416 allow customization of pressure and temperature units to suit individual preferences. The temperature widget 416 enables users to set upper and lower operating limits. The behavior (e.g., appearance) of the temperature widget 416 changes depending on the measured temperature variable being inside or outside the upper and lower operating limits, providing a clear visual cue for user analysis.

Known digital valve controllers and/or other process control products operate based on Device Descriptor (DD) technology that generally require users to navigate through several pages to potentially change a threshold value (e.g., a temperature limit). Unlike such known devices, the device overview GUI 400 displays the widgets 408, 410, 412, 414, and 416 concurrently (e.g., simultaneously) to provide intuitive “1 click” navigation that allows user-changes to different configuration parameters (e.g., bounds on a range such as temperature). For example, after a user clicks on the temperature widget 416, the device overview GUI 400 spawns (e.g., pops-up) an edit threshold window 418 that allows a user to change a temperature threshold without requiring the user to navigate away from the device overview GUI 400.

In some implementations, the digital valve controller 102 may have limited memory space (e.g., capacity of the memory system 306 of FIG. 3) to store machine-readable instructions that implement one or more of the widgets 408, 410, 412, 414, and 416 or other widgets and/or web features. To overcome such limited memory capacity, the webserver 104 is configured to communicate with third-party web browser extensions that can be developed by third parties to provide additional storage of features in web browsers that connect to the webserver 104. Third-party web browser extensions can be custom to end-customer companies. Such third-party web browser extensions can be used to enhance user experiences by adding additional features that are specific to different end users. Examples of such third-party web browser extensions include communication gateway extensions and firmware update extensions. Communication gateway extensions can be provided to provide different network configurations for communicating with the webserver 104. In some examples, a communication gateway web browser extension (e.g., a ValveLink Pro communication gateway) could configure a client device 106 to function as a gateway that is specific to an end customer without needing to have a separately configured and dedicated gateway. Firmware update extensions can be provided to update firmware in the digital valve controller 102 according to needs of different end users.

Other examples of such third-party web browser extensions can be developed to allow processing data, visualizing data, filtering data, storing data, etc. a certain way that is specific to the end customer. Some third-party web browser extensions may be developed to store video tutorials, high resolution images, user manuals, and/or any other type of information on the client device 106 that may not be possible to store on the digital valve controller 102 due to memory constraints. That is, one purpose of the web extensions is to enable access to data where the memory of the digital valve controller 102 (e.g., the memory system 306) is insufficient to store such data. In some examples, the webserver 104 of the digital valve controller 102 provides and/or includes an indication of the web browser extensions that are available. For instance, in the illustrated example of FIG. 4, the device overview GUI 400 includes an example web extensions widget 420 that lists available web browser extensions. In some examples, the list includes hyperlinks to activate and/or open the web browser extensions on the client device 106. Additionally or alternatively, in some examples, the list includes hyperlinks to website(s) where the web browser extensions can be downloaded by the client device 106 (e.g., if not already downloaded).

FIG. 5 is an example trends GUI 500 that may be served by the webserver 104 in the digital valve controller 102 of FIGS. 1 and 3 to display process variables. The trends GUI 500 includes an example graph area 502 to trend variables (e.g., travel, supply pressure, setpoint, pressure A, pressure B, etc.) and calculations (e.g., setpoint in, travel deviation, etc.) in substantially real time from the digital valve controller 102 and/or the fluid control valve 108. As discussed above, the digital valve controller 102 typically has a relatively limited memory. However, in some examples, the memory is sufficient to store trend variables and/or calculations for a most recent period of time (e.g., the last day, last week, last two weeks, last month, etc.) to generate the trends. In some such examples, if a user is interested in accessing variables and/or calculations at a point in time beyond the rolling window for which data is stored on the digital valve controller 102, the user may need to access a historical archive stored remotely from the controller 102.

As shown in the illustrated example of FIG. 5, the graph area 502 can show data from direct measurement channels that provide directly measured values corresponding to the digital valve controller and/or the fluid control valve 108. Such direct measurement data can be provided by sensors of the digital valve controller 102 and/or the fluid control valve 108. The graph area 502 can also show calculated data from calculated channels through which calculated data is obtained by performing one or more mathematical processes or other data modifications on data obtained from direct measurement channels. For example, a calculated current channel could be displayed to show current values calculated based on directly measured voltage levels and a static resistance value.

The trends GUI 500 includes an example setpoint configuration area 504 to control a setpoint (e.g., command the valve position of the fluid control valve 108) in substantially real time via button controls (e.g., -25, 0, 50, 100, 125) or a slider control. The trends GUI 500 includes an example auto calibrate button control 506 to instantiate running of auto calibration of the digital valve controller. The trends GUI 500 also includes an example step test button 508 to configure and/or run different step tests. In some examples, data associated with the auto calibration process and/or a step test is presented in substantially real time in the graph area 502 as the corresponding procedure is being completed. Providing substantially real time data associated with calibration and/or step test operations has not been possible in the past because of the speed at which known digital controllers report data. Specifically, many known digital controllers report data at a signaling rate of 1200 baud. Accordingly, in the past, when a user needs a calibration process or step test to be performed, the user initiates the process and has to wait for the process to be run through (which can take upwards of 20 minutes for relatively large valves) and then wait a number of additional minutes (as much as 15 more minutes) for the data associated with the operation to be transmitted over time before the results of the operation are presented to the user. This means the user may need to wait more than half an hour before knowing whether the operation proceeded as expected or if some issue arose. In examples disclosed herein, the data associated with valve operations (e.g., a calibration process, a step test, etc.) are provided in substantially real time. As a result, a user can quickly confirm the operation is proceeding as expected and/or identify if an error has occurred mid-operation to respond immediately, thereby saving significant amounts of time.

FIG. 6 is an example setup overview GUI 600 that may be served by the webserver 104 in the digital valve controller 102 of FIGS. 1 and 3 to display and/or configure device settings. The setup overview GUI 600 may be used to receive user configurations of types of travel control for a plunger of the fluid control valve 108 and to configure cutoff and travel limits of the plunger.

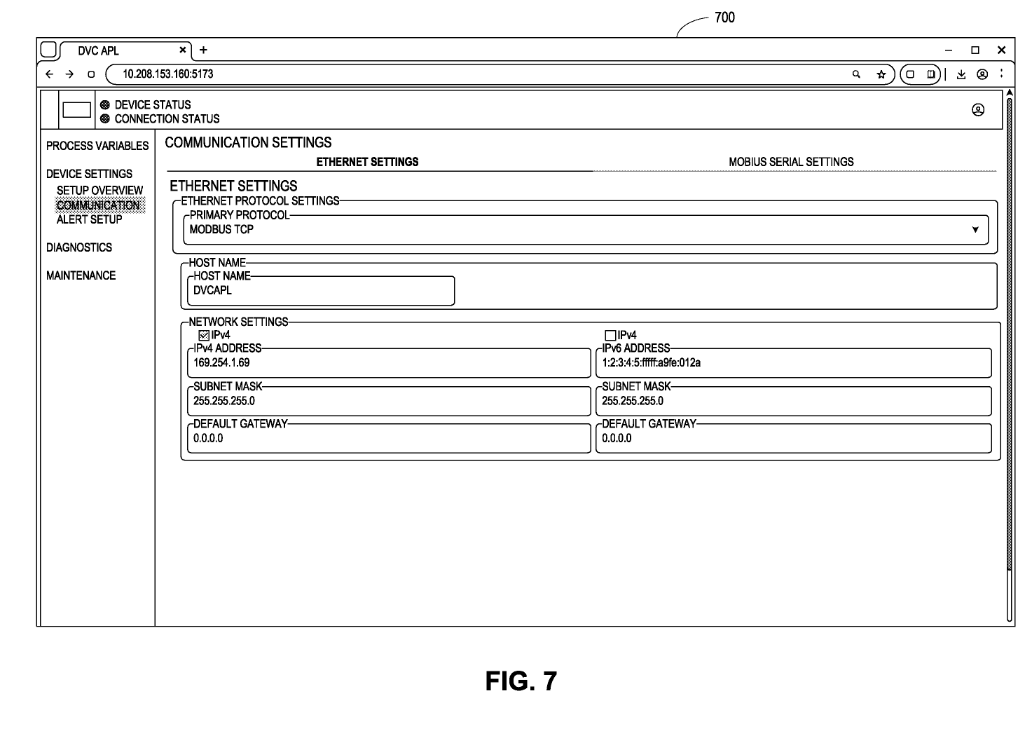

FIG. 7 is an example communications settings GUI 700 that may be served by the webserver 104 in the digital valve controller 102 of FIGS. 1 and 3 to display and/or configure device communication settings. The communications settings GUI 700 is provided to allow users to configure settings of communication protocols (e.g., Modbus transport control protocol (ModbusTCP), IPv4/IPv6, etc.).

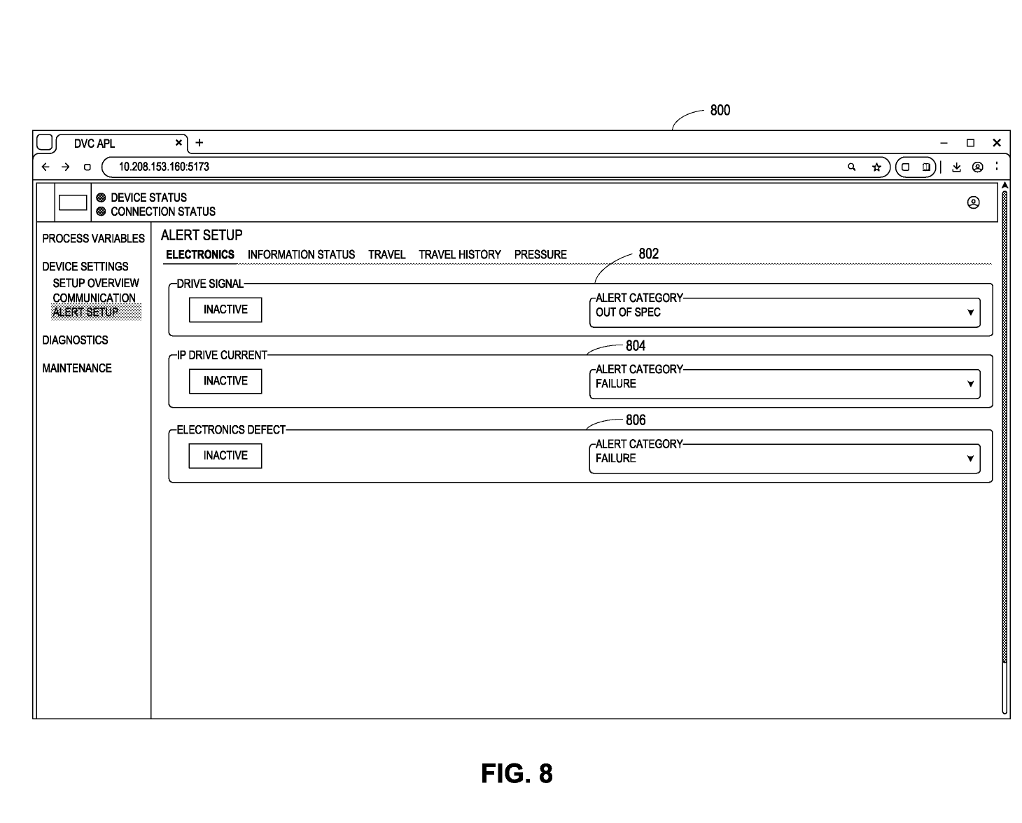

FIG. 8 is an example alert setup GUI 800 that may be served by the webserver 104 in the digital valve controller 102 of FIGS. 1 and 3 to display and/or configure device alert settings. The alert setup GUI 800 includes an example drive signal alerts configuration area 802, an example IP drive current alerts configuration area 804, and an example electronics defect alerts configuration area 806. Alerts configuration areas for other categories of alerts may additionally or alternatively be provided in the alert setup GUI 800. In some examples, NE107 category alerts may be configured in the alert setup GUI 800. As such, the alert setup GUI 800 allows users to configure different types of alerts in the digital valve controller 102. In examples disclosed herein, NE107 alerts refer to a category of notifications defined by the NAMUR user group as NE107 alerts. NE107 alerts indicate if a device is good, is failed, needs maintenance, or is out of service.

In some examples, the alert setup GUI 800 allows simulation of an alert active status and an alert inactive status so that a user can verify that an alert configuration has been properly set. Simulating alerts on prior systems overrides an actual/real alert bit on a device (e.g., a digital valve controller) due to the way prior systems were implemented (based on DD technology). Any integrations from a host (e.g., the digital valve controller) against that actual alert bit are acted on. As such, prior systems cannot readily determine what alerts are simulated and what alerts are real when a user is operating in a simulation mode. In addition, alert simulations in prior systems override real alerts. In some prior systems, such as HART devices that communicate using HART bus protocols, simulations cannot be performed when such HART devices have write protect enabled. For example, in some devices, setting an auto mode of operation enables a write-protect mode for those devices. As such, when a device is write-protect-enabled, a hardware alert bit cannot be set in the device hardware. Unlike such known systems, examples disclosed herein allow simulating alerts by providing a simulation mode in the webserver 104. In the simulation mode, a web browser interacting with the webserver 104 receives user input to set a simulation alert bit in the web browser environment and not in the hardware bits of the actual digital valve controller 102. As such, the alert is overridden only in the webserver 104. Any integrations from the webserver 104 will be acted on (e.g., displaying the active alert in a list, showing recommended actions, etc.). The digital valve controller 102 does not see the simulation alert bit changing and, therefore, does not act on the simulated alert. However, the webserver 104 can see the hardware alert bit in the digital valve controller 102 change if a real alert is activated during simulation and act accordingly. As such, a user is able to discern between a simulated alert and a real alert. This allows a user to run alert simulations while the digital valve controller 102 is in write-protect-mode. In some examples, when the digital valve controller 102 detects a real alert while a user is in the simulation mode, a notification is provided through the webserver 104 to draw the user’s attention to the real alert. In some examples, the notification includes a pop-up on top of the alert setup GUI 800 that is otherwise displaying the simulated alert data. In some examples, the alert setup GUI 800 is altered in other ways to draw a user’s attention to a real alert. For instance, the alert setup GUI 800 may be frozen and/or grayed out except in the area of the notification identifying the real alert. In some examples, depending on the type and/or severity of the real alert, the digital valve controller 102 may automatically terminate the simulation mode session of the user and switch the user back to the standard (real alert) mode to enable the user to review and respond to the real alert.

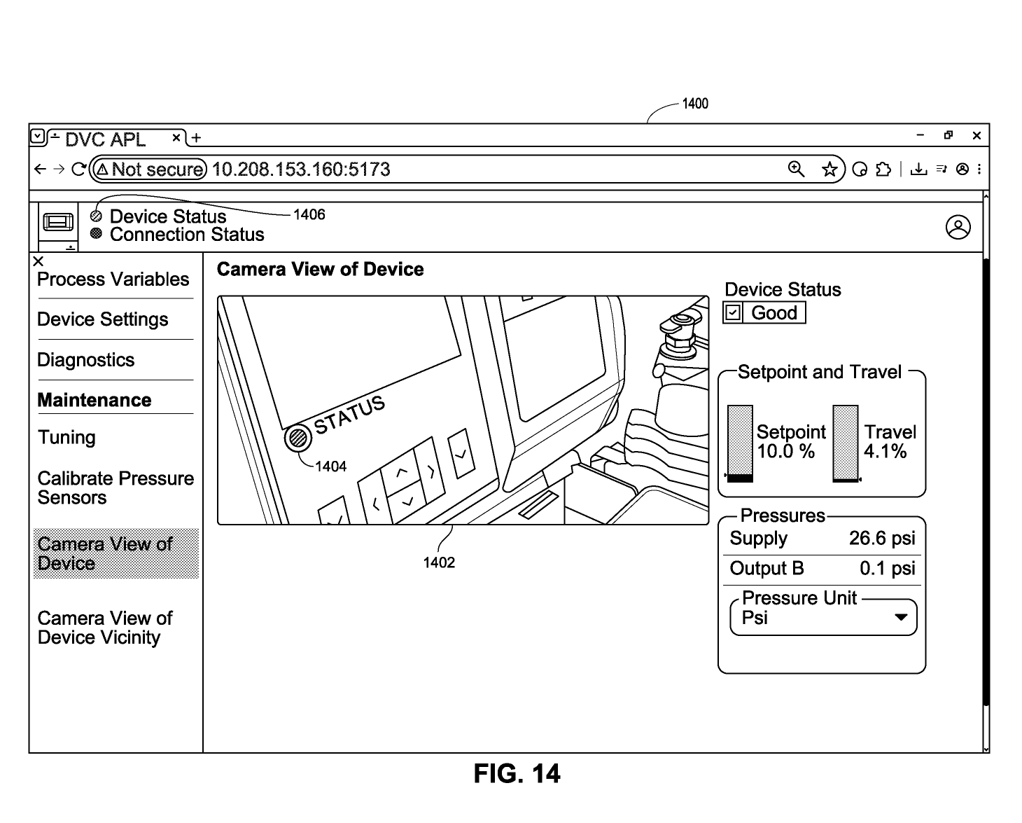

In some examples, there is some hardware integration. For example, the alert simulation can be tied into an NE107 status such that the physical LED (e.g., the hardware LED 1404 of FIG. 14) on the digital valve controller 102 can be made to change color during simulation.

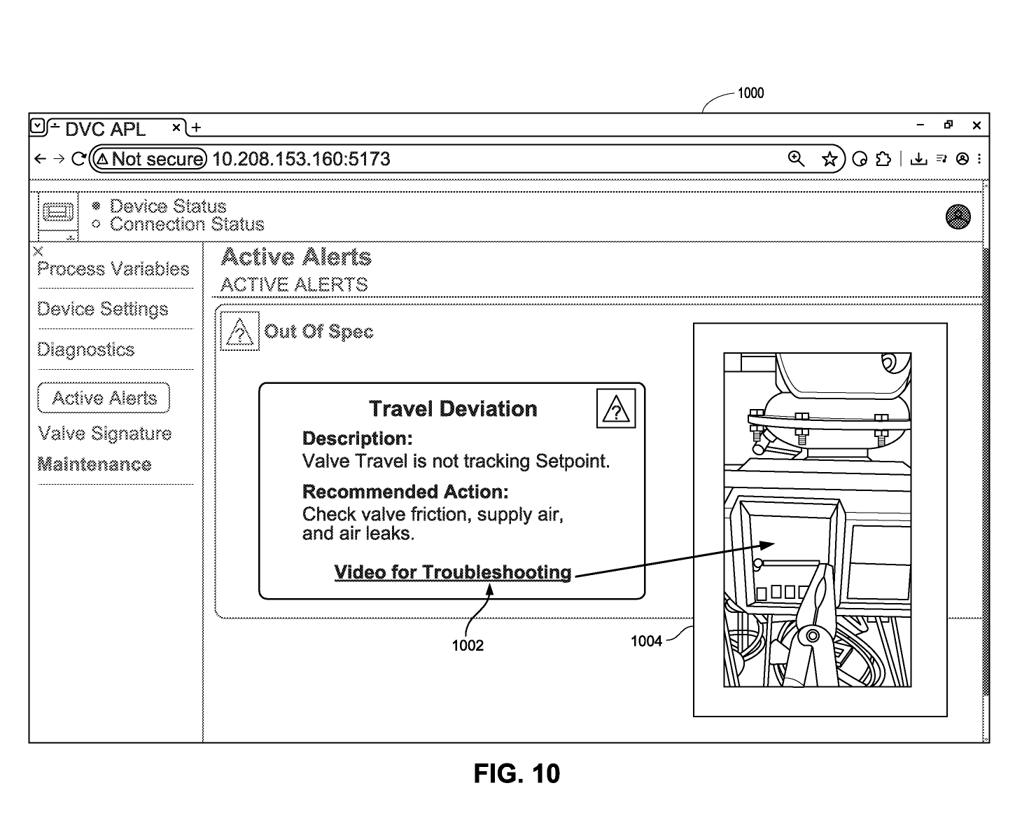

FIG. 9 is an example active alerts GUI 900 to display active diagnostic alerts, and FIG. 10 is an example video tutorial GUI 1000 to troubleshoot active diagnostic alerts. The active alerts GUI 900 and the video tutorial GUI 1000 may be served by the webserver 104 in the digital valve controller 102 of FIGS. 1 and 3. The active alerts GUI 900 includes an example alert message 902. The alert message 902 shows an active alert categorized by status and indicated by color. In the illustrated example, the alert message 902 corresponds to a travel deviation and provides a description that a valve travel is not tracking a setpoint. The alert message 902 also provides recommended actions. Example recommended actions in FIGS. 9 and 10 include checking valve friction, supply air, and air leaks. An example virtual light emitting diode (LED) bullet indicator 904 matches a hardware LED status indicator on the digital valve controller 102 so that a user can view the status of the hardware LED via a web browser through the webserver 104. For example, the virtual LED bullet indicator 904 can reflect an NE107 status of the digital valve controller 102 or any other type of status.

A user can click on the alert message 902 to see more information, as shown in FIG. 10. The video tutorial GUI 1000 of FIG. 10 shows a user-selectable video tutorial link 1002. When the video tutorial GUI 1000 receives a user selection of the video tutorial link 1002, the webserver 104 serves an example tutorial video 1004 which is displayed as an embedded video by the video tutorial GUI 1000. Accordingly, a user can view the tutorial video 1004 to troubleshoot the digital valve controller 102 and/or the fluid control valve 108.

Examples disclosed herein allow the video tutorial GUI 1000 to display tutorial videos even when an Internet connection to retrieve such videos from an internet-connected media server is not available. For example, a client device 106 may be connected to the webserver 104 via a LAN but may not have access to the Internet (e.g., an air-gapped environment). To overcome such situations, examples disclosed herein may be used to store videos locally on the digital valve controller 102 (e.g., in the memory system 306) so that the webserver 104 can deliver the videos from the digital valve controller 102 to a web browser of the client device 106 via the LAN. In such examples, the videos can be loaded in the digital valve controller 102 when the digital valve controller 102 is connected to the Internet and is able to download the videos from an internet-connected media server in advance of a user requesting to view the videos. As discussed above, in some cases, the digital valve controller 102 may not have sufficient storage for the videos. Accordingly, examples disclosed herein may additionally or alternatively be implemented to store videos at the client device 106 in a web browser extension on the client device 106 so that the web browser of the client device 106 can load the videos for a user even when the client device 106 is offline from the Internet. In such examples, the videos can be loaded in the web browser extension when the client device 106 is connected to the Internet and is able to download the videos from an internet-connected media server in advance of a user requesting to view the videos. In some examples, the web browser extensions can be configured to interact with licensing features associated with installing the browser extensions and/or with accessing licensed video content from internet-connected media servers.

Providing video tutorials (e.g., the tutorial video 1004 of FIG. 10) in the video tutorial GUI 1000 allows users to readily understand an alert code signaled by the virtual LED bullet indicator 904 and how to address it (e.g., how to fix a problem). Directly associating alert codes signaled by the virtual LED bullet indicator 904 with related information in the active alerts GUI 900 and in the video tutorial GUI 1000 significantly decreases the amount of device downtime by decreasing the amount of research needed to be performed by a user to solve a problem with the device.

In some examples, licenses for different diagnostic features, configuration features, maintenance features, etc. can be stored in the digital valve controller 102 (e.g., in the memory system 306) and/or on one or more web browser extensions on the client devices 106 so that such licensed features can be accessed by the client devices 106 when Internet connectivity is not available to communicate with a licensing server. In such examples, when a user requests access to a licensed feature, a web browser extension can produce the corresponding license and/or request the corresponding license from the digital valve controller 102 so that access to the licensed feature is granted for the user.

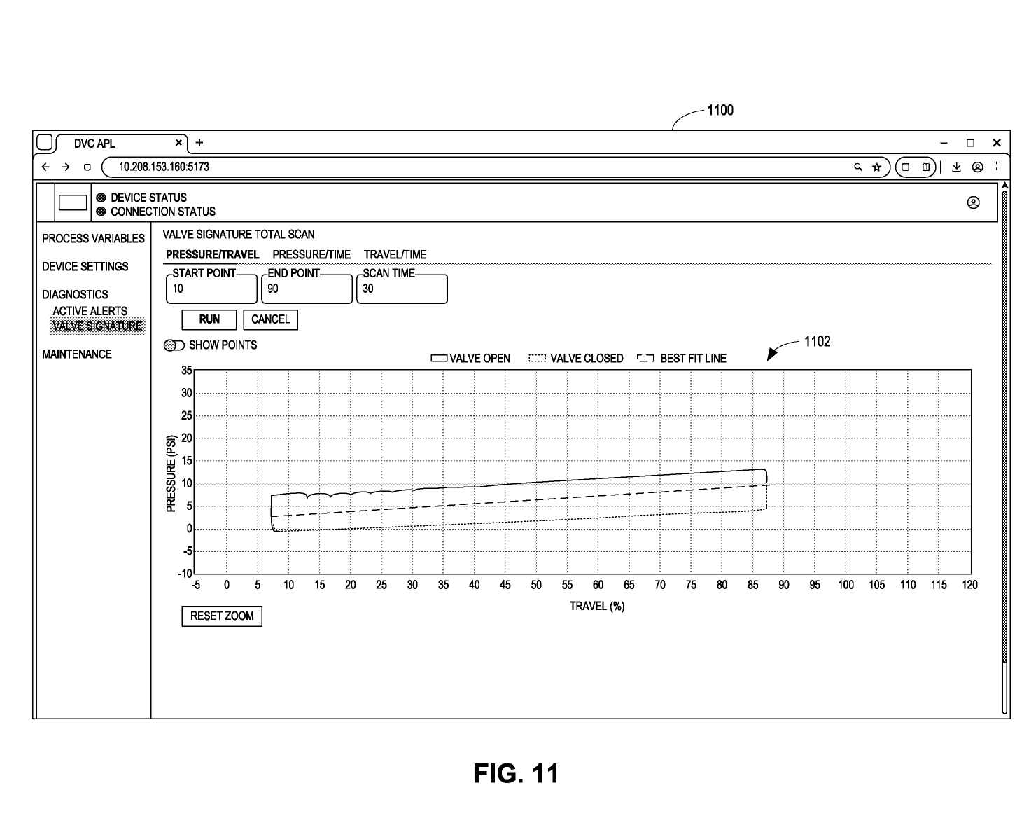

FIG. 11 is an example valve signature total scan GUI 1100 that may be served by the webserver 104 in the digital valve controller 102 of FIGS. 1 and 3 to display diagnostic valve signatures. As used herein, a valve signature represents correlations between spring force and diameter pressure of a fluid control valve (e.g., the fluid control valve 108). As such, a valve signature is a unique characteristic of a valve’s response relative to spring force input to the valve. The valve signature total scan GUI 1100 includes an example signature graph area 1102 that displays a valve signature of the fluid control valve 108. The signature graph area 1102 allows a user to configure and run valve signatures and see data updated live. Examples disclosed herein allow the signature graph area 1102 to show progress of diagnostics as live streaming data (e.g., in substantially real time) without missing points. For example, to not miss points of diagnostics, the signature graph area 1102 displays progress with live stream data and simultaneously stores the live valve signature data in its entirety to a file (e.g., a diagnostics file). In such examples, even if the signature graph area 1102 omits some data points from the displayed live stream data (e.g., the live stream data is down sampled relative to the full data saved in the diagnostic file), such omitted data points are saved in the diagnostics file. Accordingly, a subsequent analysis process can be used to run diagnostics on the entirety of the valve signature data in the file.

By displaying updated live valve signature data, a user can see in substantially real time whether there are undesirable response characteristics of a particular valve. For example, oscillatory behavior represented in live valve signature data may be undesirable. When a user identifies such undesirable condition in substantially real time, the user can stop operation of the valve immediately and resolve whatever issue may be causing such an undesirable behavior. This decreases configuration and maintenance time with troubleshooting and/or bringing a valve online relative to prior systems that cannot provide real-time data because of the limited communication speeds outlined above in connection with displaying calibration processes and/or step tests in substantially real time discussed in connection with FIG. 5.

FIG. 12 is an example tuning GUI 1200 that may be served by the webserver 104 in the digital valve controller 102 of FIGS. 1 and 3 to perform tuning maintenance. The tuning GUI 1200 includes example travel tuning configuration controls 1202 that provide the ability to update travel tuning sets in the digital valve controller 102 for use in operating the fluid control valve 108.

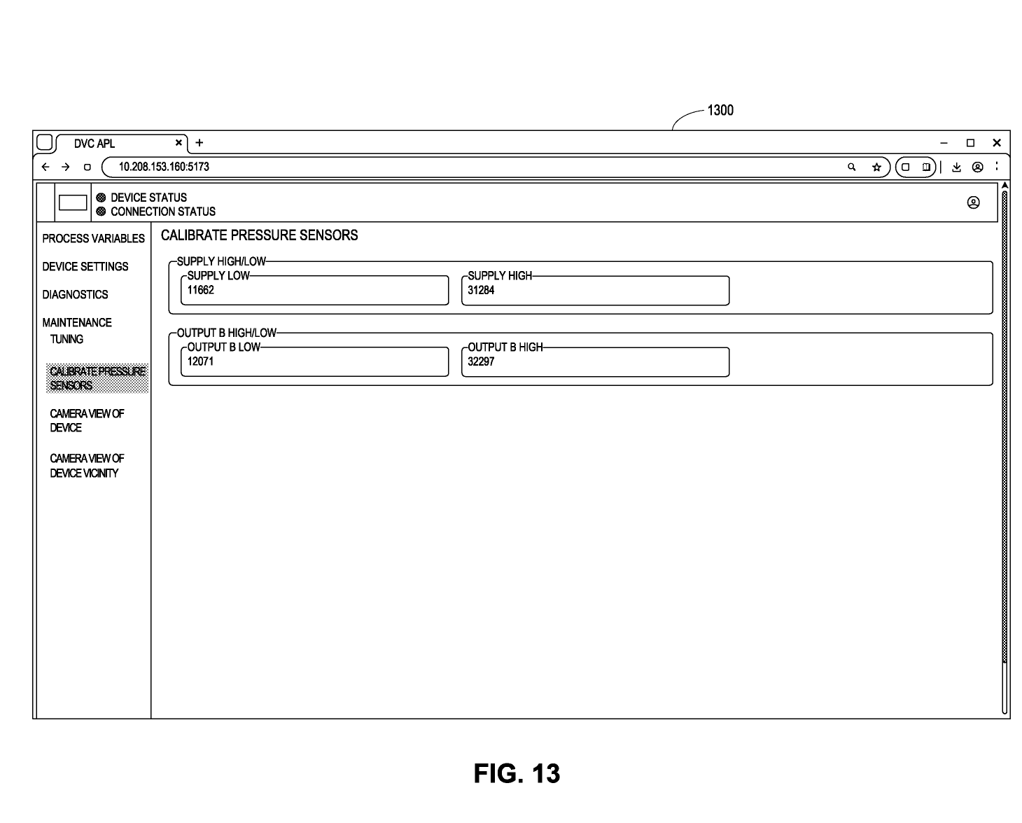

FIG. 13 is an example calibrate pressure sensors GUI 1300 that may be served by the webserver 104 in the digital valve controller 102 of FIGS. 1 and 3 to perform calibration maintenance. The calibrate pressure sensors GUI 1300 provides the ability to set counts for pressure sensor calibration of pressure sensors corresponding to the fluid control valve 108.

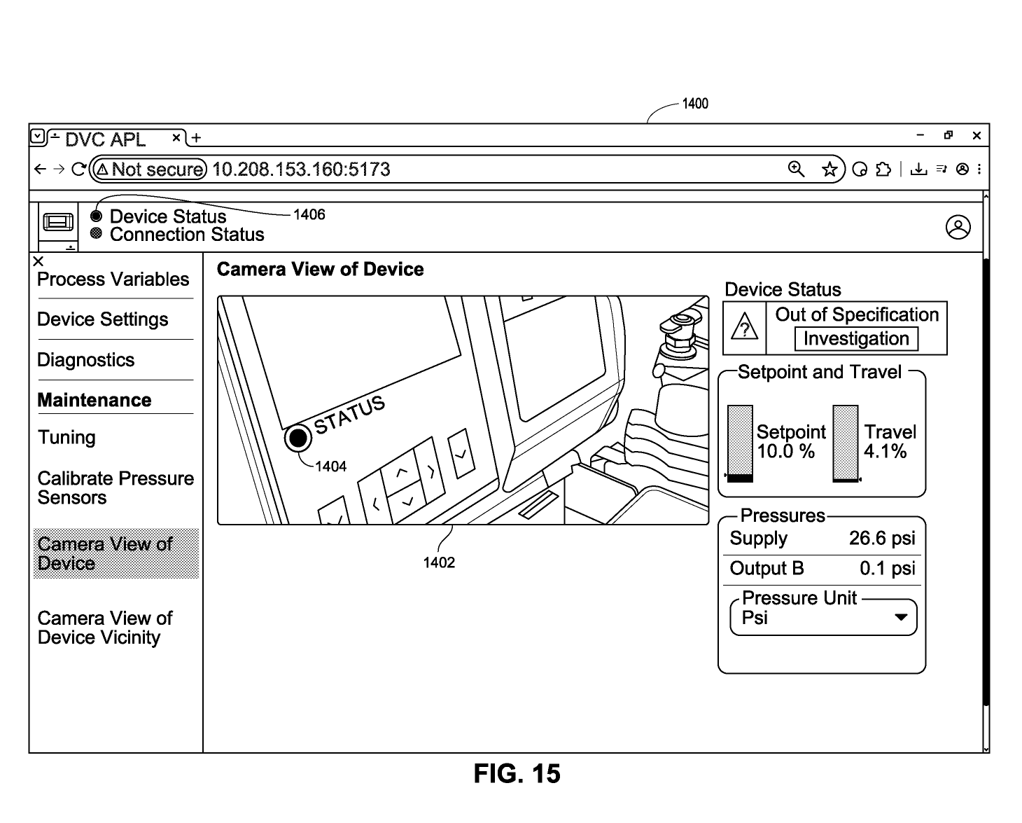

FIGS. 14 and 15 show an example camera view of device GUI 1400 that may be served by the webserver 104 in the digital valve controller 102 of FIGS. 1 and 3 to perform connectivity maintenance. The camera view of device GUI 1400 includes an example live video stream area 1402 that presents a live video stream of a camera (e.g., the camera 110 of FIG. 1) pointed toward a front face of the digital valve controller 102. In the example of FIGS. 14 and 15, the front face of the digital valve controller 102 includes an example hardware LED 1404 that can be monitored remotely through the live video stream area 1402. The camera view of device GUI 1400 also includes an example virtual LED 1406 that reflects the same color status emitted by the hardware LED 1404. For example, the hardware LED 1404 and the virtual LED 1406 can represent an NE107 status or any other type of status based on different colors. When the color status changes on the hardware LED 1404, the virtual LED 1406 is updated to show the same color. For example, the hardware LED 1404 and the virtual LED 1406 may both be green in color in FIG. 14 based on the “Good” device status represented in FIG. 14. Alternatively, in the example of FIG. 15, the hardware LED 1404 and the virtual LED 1406 may both be yellow in color based on the “Out of Specification” device status represented in FIG. 15. Users may use the camera view of device GUI 1400 to confirm that the webserver 104 is properly synchronized with operation of the digital valve controller 102. If not properly synchronized, a user may perform connectivity maintenance to re-connect and/or re-synchronize the webserver 104 with the digital valve controller 102.

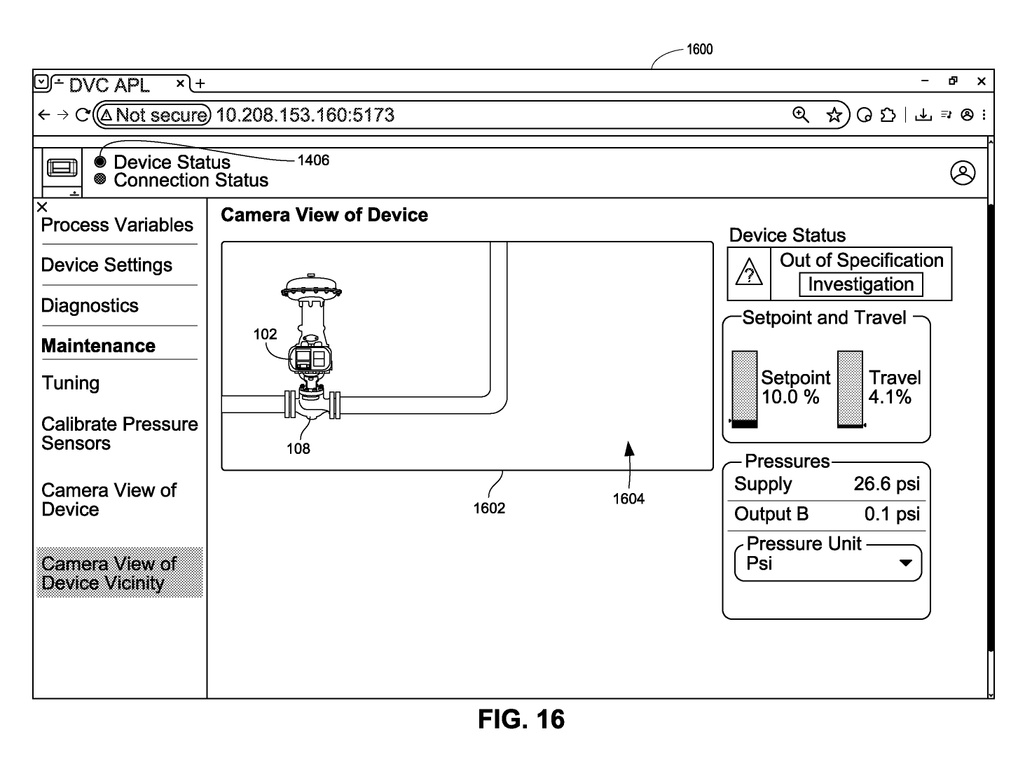

In some examples, a live stream of other camera views of the vicinity of the digital valve controller 102 may additionally or alternatively be provided via the webserver 104 of the digital valve controller 102. For instance, FIG. 16 shows an example camera view of device vicinity GUI 1600 that may be served by the webserver 104 in the digital valve controller 102 of FIGS. 1 and 3. The camera view of the device vicinity GUI 1600 includes an example live video stream area 1602 that presents a live video stream of the camera 110 that captures a vicinity of the digital valve controller 102. In some examples, the camera 110 can be focused on the fluid control valve 108 to which the digital valve controller 102 is attached. In some examples, the camera 110 captures a close up view of the fluid control valve 108 that, depending on the perspective, partially or completely omits the digital valve controller 102. In the illustrated example, the camera 110 is positioned to capture a larger vicinity including the digital valve controller 102, the fluid control valve 108, and an adjacent area 1604. In this example, the adjacent area 1604 corresponds to a workspace and/or walkway for personnel. As such, the camera view of the device vicinity GUI 1600 can enable a user to identify whether people are present adjacent to the digital valve controller 102 and the associated fluid control valve 108. In other examples, the camera view can be positioned to capture other conditions and/or areas in the vicinity of the digital valve controller 102. For instance, a live camera feed can enable remote users to visually inspect the device and/or environment for abnormal conditions without requiring immediate on-site access. In some examples, a live camera feed can enable remote users to assess environmental and/or safety conditions in the vicinity of the device prior to dispatching personnel and/or to prepare such personnel to deal with the conditions (e.g., the video feed can reveal hazardous conditions like fluid or gas leaks, spraying chemicals or oil, excessive vibration causing camera shake or other unsafe operating conditions). In some examples, a live camera feed can enable a remote user to monitor and/or collaborate with (e.g., provide guidance, feedback, and/or validation of procedures performed by) other personnel in the vicinity of the device via the user interface. In some examples, the camera 110 is adjacent to (e.g., mounted on) and oriented to face away from the digital valve controller 102. In such examples, the live video stream area 1602 depicts an adjacent area (e.g., the area 1604) without showing the digital valve controller 102 or the fluid control valve 108.

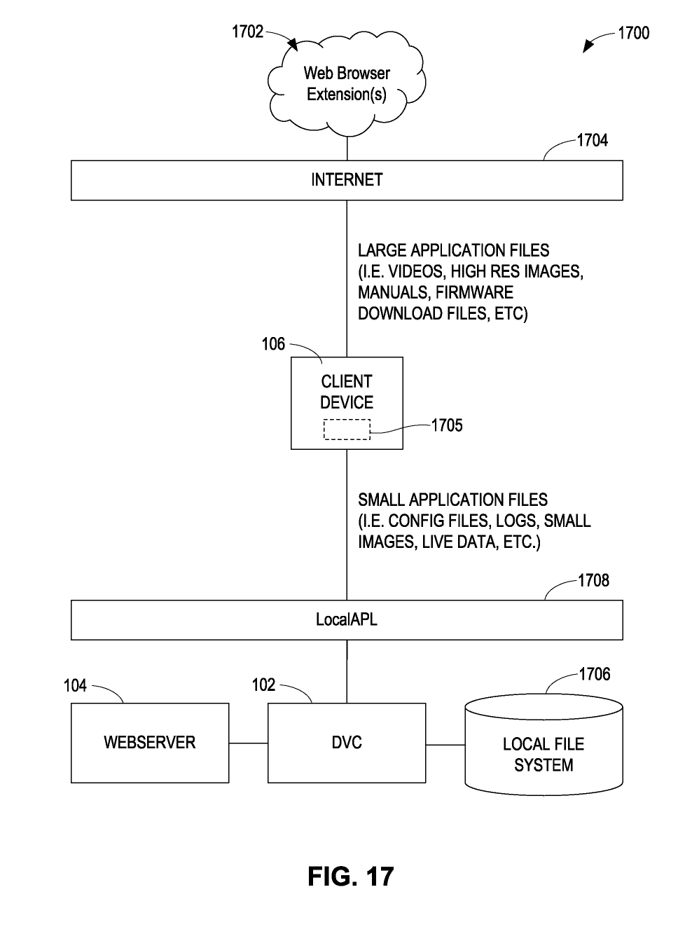

FIG. 17 is a block diagram of an example system 1700 to enable the client device 106 to access the webserver 104 of the digital valve controller 102 and also to access large files from one or more web browser extension(s) 1702. In this example, the web browser extension(s) 1702 are downloaded via the Internet 1704 using a browser 1705 on the client device 106. In some situations, the client device 106 may not have access to the Internet 1704 when the client device 106 is connected to digital valve controller 102. Accordingly, in some examples, to have access to the information and/or files provided by the web browser extension(s) 1702 when connected to the digital valve controller 102, the client device 106 needs to download the extension(s) 1702 in advance. As discussed above, an important reason for the web browser extension(s) 1702 is to enable the client device 106 to have access to relatively large files, applications, tools, and/or information (e.g., videos, high resolution images, manuals, diagnostic tools, etc.) that cannot be stored locally by the digital valve controller 102 due to the limited memory capacity of the local file system 1706 (e.g., the memory system 306 of FIG. 3) associated with the digital valve controller 102. In disclosed examples, such large files and/or applications are stored in the memory of the client device 106. In some examples, the files, applications, tools, and/or information is contained in the web browser extension(s) 1702 even if it could be stored locally by the digital valve controller 102. That is, file size is not the only reason to use the web browser extension(s) 1702. For instance, in some examples, a new diagnostic tool may be developed that is not included within the firmware of the digital valve controller 102 because of its later development. In some such examples, the new diagnostic tool can be implemented directly on the client device 106 (via the web browser extension 1702) without having to be executed on the digital valve controller 102. Additionally or alternatively, in some examples, the digital valve controller 102 can be updated to include the new diagnostic tool by installing the new tool obtained from the client device 106 via the web browser extension 1702. More generally, in some examples, a web browser extension 1702 can include firmware update files for the digital valve controller 102 (whether or not the update include new diagnostic tools) that can be provided by the client device 106 to the digital valve controller 102 for updating.

In the illustrated example of FIG. 17, the client device 106 is connected to the digital valve controller via a local Advanced Physical Layer (APL) 1708 (e.g., an Ethernet APL). In some examples, the client device 106 accesses information on the digital valve controller 102 using the browser 1705 to connect with the webserver 104. Whereas large files may be stored directly on the client device 106 when corresponding web browser extension(s) 1702 are downloaded, smaller files, applications, and/or information (e.g., configuration files, logs, small images, live data, etc.) is provided directly by the digital valve controller 102 through the webserver 104.

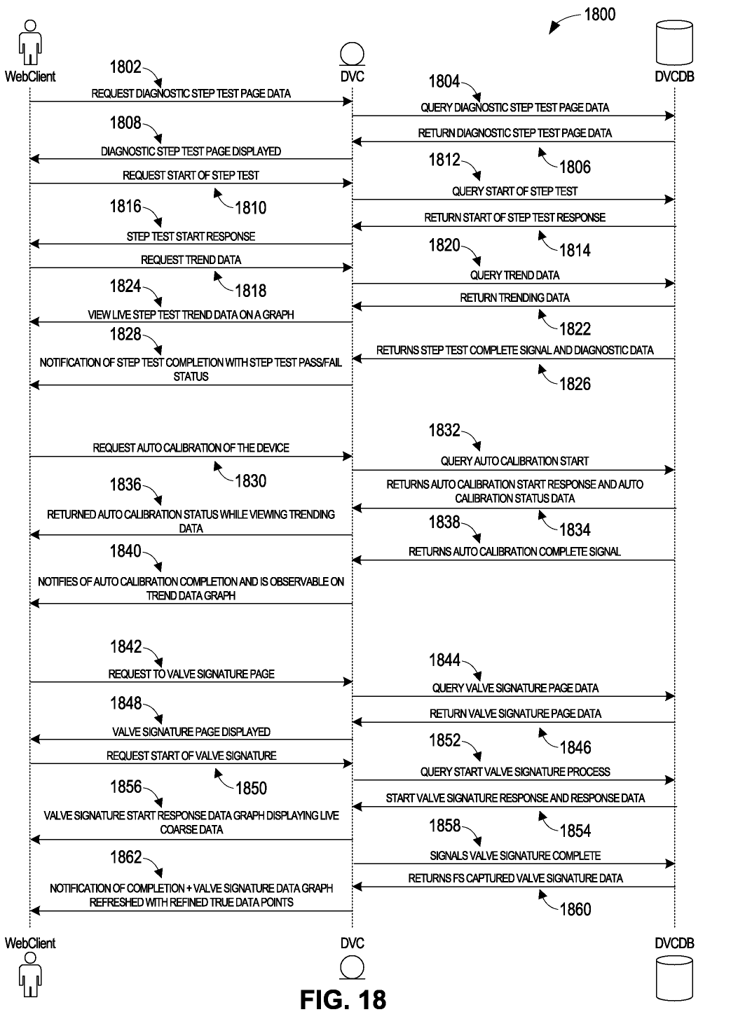

FIG. 18 is an example operations sequence 1800 involving interactions between the client device 106 and the digital valve controller 102 to implement a step test, an auto calibration process, and/or a valve signature process. At a first point in time 1802, a user uses the browser 1705 on the client device 106 to request and/or access the diagnostic step test page from the webserver 104 of the digital valve controller 102. At the next point in time 1804, the webserver 104 of the digital valve controller 102 requests the diagnostic step test page from a database of the digital valve controller (e.g., the memory system 306 of FIG. 3 and/or the local file system 1706 of FIG. 17). At the next point in time 1806, the database returns the diagnostic step test page. At the next point in time 1808, the webserver 104 provides the diagnostic step test page to the client device 106 (e.g., for presentation via the browser 1705). In some examples, the diagnostic step test page is accessed through and/or corresponds to example trends GUI 500 of FIG. 5.

Once the diagnostic step test page is provided to the user via the client device 106, the user can request to start a step test at a subsequent point in time 1810. At a next point in time 1812, the digital valve controller 102 initiates the step test and queries the database to confirm the step test has started. At the next point in time 1814, the database returns a start step test response. At the next point in time 1816, the webserver 104 provides the response to the client device 106 (e.g., for presentation via the browser 1705). At a next point in time 1818, the client device 106 provides a request for trend data associated with the step test. In some examples, this request is initiated by the user. In some examples, this request is automatically generated based on the user request to initiate the step test. At a next point in time, 1820, the digital valve controller 102 queries the database for the trend data. At a next point in time 1822, the database returns the trend data. In some examples, the database returns the trend values in substantially real time to when they are being collected and/or measured. Accordingly, at the next point in time 1824, the live (e.g., substantially real time) trend data is provided to the client device 106 for presentation on a graph (e.g., in the graph area 502 of FIG. 5). In some examples, real-time data is shared with the client device 106 based on the WebSocket protocol that permits real-time data transfers between the browser 1705 of the client device 106 and the webserver 104 of the digital valve controller 102. Once the step test is completed, at a later point in time 1826, the database returns a step test complete signal and any associated diagnostic data (e.g., notable issues identified during the test). At a next point in time 1828, a notification of the step test completion with a pass/fail status is provided to the client device 106 for presentation via the browser 1705. Once the step test is completed, the fluid control valve 108 returns to normal operation and its operation continues to be observable via the trends GUI 500. In some such examples, the step test data persists on the trends GUI 500 and is available for snapshot and/or logging.

Additionally or alternatively, at a different point in time 1830, a user can request an auto calibration of the device. At a next point in time, 1832, the digital valve controller 102 initiates the auto calibration process and queries the database to confirm the auto calibration process has started. At the next point in time 1834, the database returns a start response for the auto calibration process along with associated status data. At the next point in time 1836, the webserver 104 provides the status data to the client device 106 for presentation via the browser 1705. In some examples, the status data is provided on an ongoing basis in substantially real time to update a graph showing the associated trend data. In some examples, real-time data is shared with the client device 106 based on the WebSocket protocol. Once the auto calibration process is completed, at a later point in time 1838, the database returns an auto calibration complete signal. At a next point in time 1840, a notification of the auto calibration completion is provided to the client device 106 that may be presented along with the associated trend data.

Additionally or alternatively, at a different point in time 1842, a user uses the browser 1705 on the client device 106 to request and/or access the valve signature page from the webserver 104 of the digital valve controller 102. At the next point in time 1844, the webserver 104 of the digital valve controller 102 requests the valve signature page from the database of the digital valve controller 102. At the next point in time 1846, the database returns the valve signature page. At the next point in time 1848, the webserver 104 provides the valve signature page to the client device 106 (e.g., for presentation via the browser 1705). In some examples, the valve signature page is accessed through and/or corresponds to the example valve signature total scan GUI 1100 of FIG. 11.

Once the valve signature page is provided to the user via the client device 106, the user can request to start a step test at a subsequent point in time 1850. At a next point in time 1852, the digital valve controller 102 initiates the valve signature and queries the database to confirm the valve signature has started. At the next point in time 1854, the database returns a start valve signature response along with associated response data. At the next point in time 1856, the webserver 104 provides the response to the client device 106 (e.g., for presentation via the browser 1705). As discussed above for the step test and calibration process, the progress of the valve signature procedure can be displayed in substantially real time. In some examples, real-time data is shared with the client device 106 based on the WebSocket protocol. In this example, the substantially real time data is only coarse data (e.g., down sampled) relative to the full data captured during the valve signature process. However, in some such examples, the live data is presented with sufficient granularity to provide a clear indication of the process to the user. In some examples, at a later point in time 1858, once the valve signature and associated processing of the data is completed, the digital valve controller 102 provides a signal to the database that the process is complete to request the full valve signature data stored in a file system of the device. At a next point in time 1860, the database returns the full valve signature data. At a next point in time 1862, a notification of completion of the valve signature is provided. In some examples, the valve signature data graph displayed on the client device 106 is refreshed with the refined true data points (e.g., the full valve signature data). That is, in some examples, the webserver 104 overwrites the previously live streamed data (that was down sampled) with the full valve signature data.

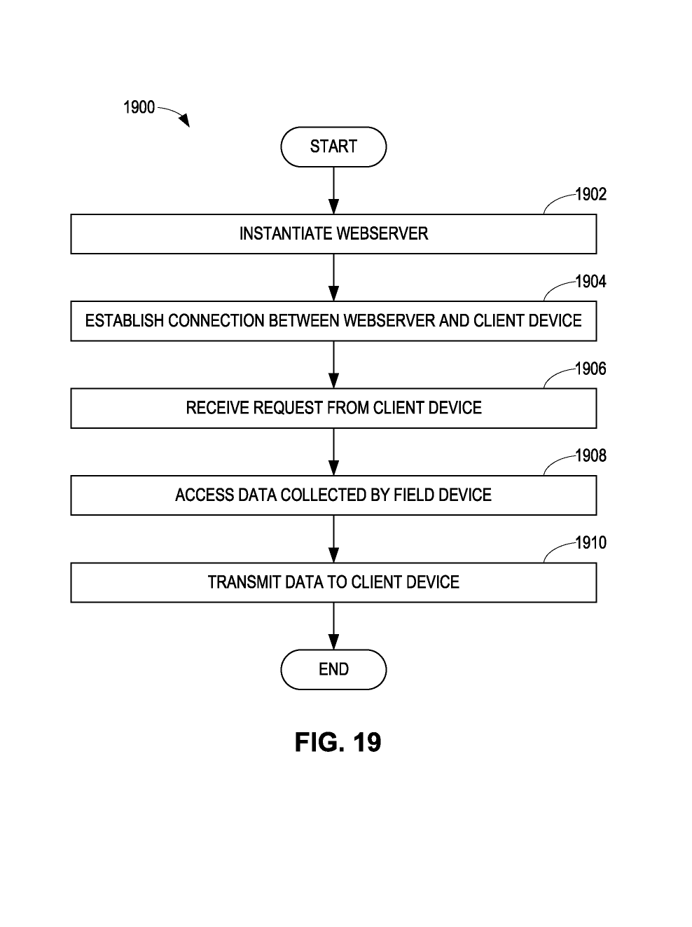

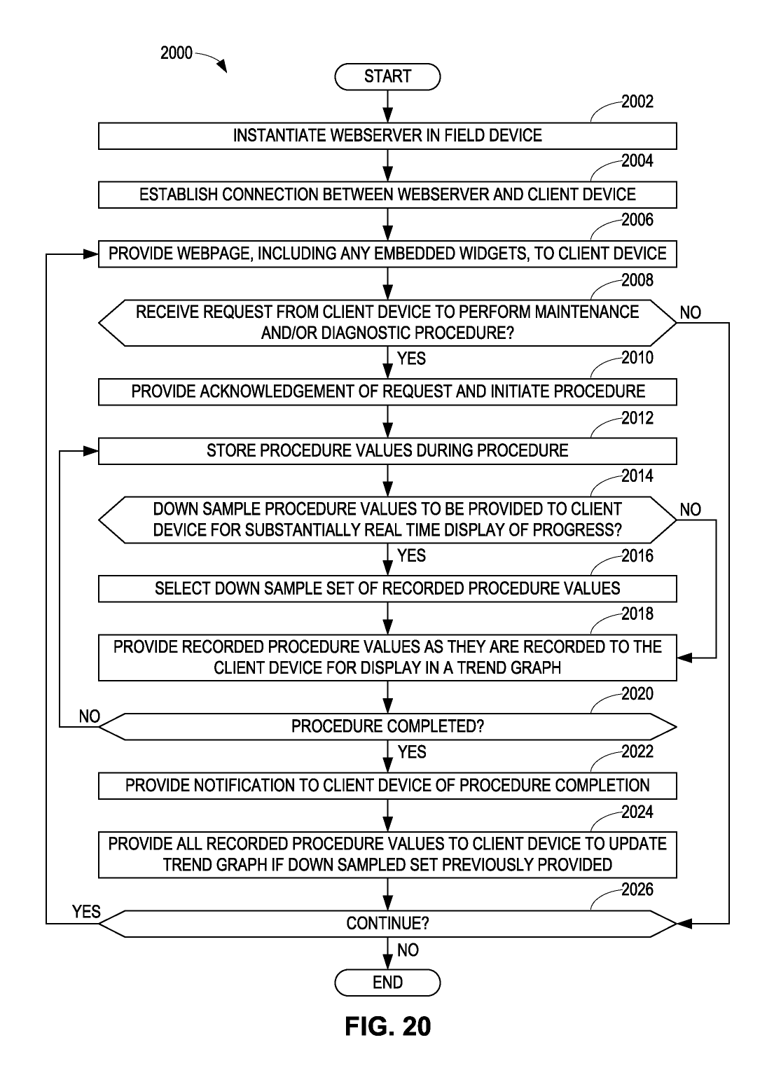

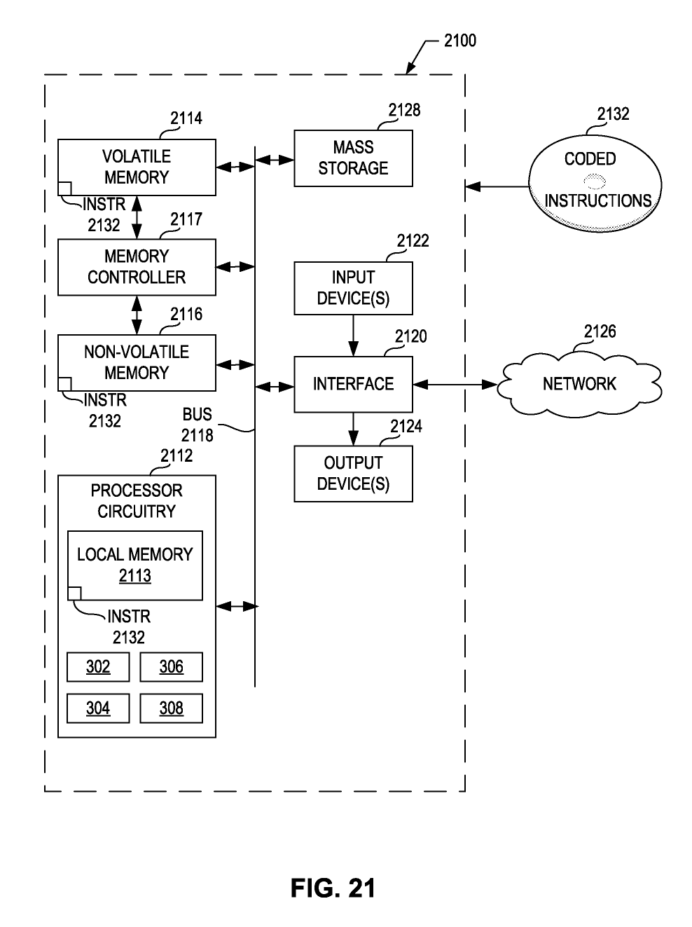

Flowcharts representative of example machine-readable instructions, which may be executed by programmable circuitry to implement and/or instantiate the digital valve controller 102 and the webserver 104 of FIGS. 1 and 3 and/or representative of example operations which may be performed by programmable circuitry to implement and/or instantiate the digital valve controller 102 and the webserver 104 of FIGS. 1 and 3, are shown in FIGS. 19 and 20. The machine-readable instructions may be one or more executable program(s) or portion(s) of one or more executable program(s) for execution by programmable circuitry such as the programmable circuitry 2112 shown in the example processor platform 2100 discussed below in connection with FIG. 21 and/or may be one or more function(s) or portion(s) of functions to be performed by other types of programmable circuitry (e.g., an FPGA). In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine-readable storage media such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, read-only memory (ROM), a solid-state drive (SSD), non-volatile memory (e.g., electrically erasable programmable ROM (EEPROM), flash memory, etc.), volatile memory (e.g., Random Access Memory (RAM) of any type, etc.), and/or any other storage device or storage disk. The non-transitory computer readable storage medium may include one or more mediums and/or types of mediums. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or may be embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, any or all of the blocks of the flowchart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform corresponding operations without executing software or firmware.

Although the example program(s) is/are described with reference to the flowchart illustrated in FIGS. 19 and 20, many other methods of implementing the example digital valve controller 102 may alternatively be used. For example, the order of execution of the blocks of the flowchart may be changed, and/or some of the blocks described may be changed, eliminated, or combined.

The programmable circuitry may be distributed in different network locations and/or may be local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above. As used herein, the term “circuitry” refers to at least one “circuit.” Thus, circuitry refers to a circuit or a system of circuits. As used herein, programmable circuitry includes and/or corresponds to at least one programmable circuit.

The machine readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) and/or in a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine-readable instructions described herein can be written or represented using any suitable previously developed or future-developed instruction language, scripting language, programming language, etc. including, for example, C, C++, Java, C-Sharp, Perl, Python, JavaScript, HyperText Markup Language (HTML), Structured Query Language (SQL), Swift, etc.

As mentioned above, the example operations of FIGS. 19 and 20 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. As used herein, the terms “non-transitory computer-readable storage device” and “non-transitory machine readable storage device” are defined to include any physical (mechanical, magnetic and/or electrical) hardware to retain information for a time period, but to exclude propagating signals and to exclude transmission media. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc. As used herein, the term “storage disk” refers to a physical structure containing information storage elements to which information can be written and persisted for subsequent retrieval by a computer or other hardware platform. Examples of non-transitory computer-readable medium, non-transitory computer-readable storage medium, non-transitory machine-readable medium, non-transitory machine-readable storage medium, non-transitory computer-readable storage devices, non-transitory machine-readable storage devices, non-transitory computer-readable storage disk, and/or non-transitory machine-readable storage disk include any one of or combination of random access memory (RAM) of any type, read only memory (ROM) of any type, solid state memory, flash memory, optical discs (e.g., a CD, a DVD, etc.), magnetic disks (e.g., magnetic HDDs), disk drives, cache, registers, redundant array of independent disks (RAID) systems, and/or any other non-transitory computer-readable and/or machine-readable media in which information is stored for any duration (e.g., for extended time periods, permanently, for brief instances, for temporarily buffering, and/or for caching of the information).

FIG. 19 is a flowchart representative of example machine-readable instructions and/or example operations 1900 that may be executed, instantiated, and/or performed by programmable circuitry to implement the digital valve controllers and webservers of FIGS. 1-3. The example machine-readable instructions and/or the example operations 1900 of FIG. 19 begin at block 1902, at which the programmable circuitry 304 instantiates a webserver in a field device in a control system. For example, the programmable circuitry 304 instantiates the webserver 104 in the digital valve controller 102. At block 1904, the interface circuitry 302 establishes a connection between the webserver 104 and a client device 106. At block 1906, the interface circuitry 302 receives a request from the client device 106 (e.g., based on a user input to the client device 106). For example, the interface circuitry 302 receives a hypertext transfer protocol (HTTP) request from the client device 106 that is indicative of a request for the webserver 104 to provide data to the client device 106. The data may be substantially real-time data collected by the digital valve controller 102 from one or more sensors that measure pressure, temperature, valve travel, etc. associated with the fluid control valve 108. At block 1908, the interface circuitry 302 accesses data collected by the digital valve controller 102. For example, the interface circuitry 302 accesses the data from the memory system 306 and/or status bits of the digital valve controller 102 and/or the webserver 104. In some examples, the data is substantially real-time data collected from one or more sensors by the digital valve controller 102. At block 1910, the interface circuitry 302 transmits the requested data to the client device 106 before the example process ends. In some examples, the interface circuitry 302 transmits a command directing the client device 106 to access a web browser extension to provide data to be presented on the client device 106. In some such examples, the web browser extension is stored in the memory of the client device 106.

Additionally or alternatively, the request of block 1606 may cause the webserver 104 to enter a simulation mode and cause the programmable circuitry 304 to write to a simulation alert bit in the webserver 104 without writing to a hardware alert bit in the digital valve controller 102. In such examples, the data may be an alert notification representative of a simulation alert based on the simulation alert bit of the webserver 104 and/or a real alert based on the hardware alert bit of the digital valve controller 102. Also in such examples, the interface circuitry 302 transmits a simulated alert and/or a real alert to the client device 106.

FIG. 20 is a flowchart representative of example machine-readable instructions and/or example operations 2000 that may be executed, instantiated, and/or performed by programmable circuitry to implement the digital valve controllers and webservers of FIGS. 1-3. The flowchart of FIG. 20 provides more specific details (relative to FIG. 19) to provide substantially real-time data to a user of a client device 106 connected to the digital valve controller 102 via the webserver 104 of the digital valve controller 102. The example machine-readable instructions and/or the example operations 2000 of FIG. 20 begin at block 2002, at which the programmable circuitry 304 instantiates a webserver in a field device in a control system. For example, the programmable circuitry 304 instantiates the webserver 104 in the digital valve controller 102. At block 2004, the interface circuitry 302 establishes a connection between the webserver 104 and a client device 106. At block 2006, the interface circuitry 302 provides a webpage, including any embedded widgets, to the client device 106. For example, the webserver 104 generates a webpage as part of the GUI 308 including a plurality of widgets and populates the widgets with corresponding data. In such examples, the interface circuitry 302 transmits data to the client device 106 associated with corresponding ones of the widgets of the webpage.

At block 2008, the interface circuitry 302 determines whether a request for data has been received from the client device 106. In some examples, the request is based on a user of the client device 106 interacting with one of the widgets. In some examples, the request is based on the user navigating to a different webpage and/or selecting a different option on the current webpage and/or a different webpage to which the user has navigated. For example, the request of block 2008 may include a calibration request from the client device 106 to cause the programmable circuitry 304 to update a calibration of the digital valve controller 102. Additionally or alternatively, in some examples, the request of block 2008 may include a request from the client device 106 to cause the programmable circuitry 304 to perform a step test of a process control component (e.g., the fluid control valve 108) associated with the digital valve controller 102. Additionally or alternatively, in some examples, the request of block 2008 may include a request from the client device 106 to cause the programmable circuitry 304 to generate and store signature data of a process control component (e.g., the fluid control valve 108) associated with the digital valve controller 102. If no request is received at block 2008, the operations 2000 advance to block 2026. If a request is received, the operations advance to block 2010.

At block 2010, the interface circuitry 302 provides an acknowledgement of the request and the programmable circuitry 304 initiates the requested procedure. At block 2012, the memory system 306 stores procedure values (e.g., calibration data, step test data, signature data) during the procedure. At block 2012, the programmable circuitry 304 determines whether to down sample the procedure values to be provided to the client device for substantially real time display of progress through the procedure. For example, in the case of a valve signature procedure, the programmable circuitry 304 causes the memory system 306 to store the signature data as a more granular dataset than the substantially real-time signature data to be transmitted to the client device 106. For example, transmission of the substantially real-time signature data may result in non-transmission or failed transmission of some signature data due to transmission delays being longer than data acquisition speeds of the signature data. As such, a more complete dataset of the signature data can be stored in memory for subsequent retrieval/analysis while a substantially real-time display of the substantially real-time data at the client device 106 can be used to quickly make decisions regarding the digital valve controller 102 and/or the fluid control valve 108. Thus, if the procedure values are to be down sampled (as determined at block 2014), control advances to block 2016, at which the programmable circuitry 304 selects the down sampled set of recorded procedure values. Thereafter, control advances to block 2018. Returning to block 2014, if the procedure values are not to be down sampled, control advances directly to block 2018.

At block 2018, the interface circuitry provides the recorded procedure values (either the full data or the down sampled data set) as they are recorded (e.g., in substantially real-time) to the client device 106 for display in a trend graph (e.g., via the GUI 308). In some examples, where calibration was requested, the substantially real-time data is representative of a change in operation associated with the digital valve controller 102 based on the calibration. In other examples, where a step test or valve signature procedure was requested, the substantially real-time data is representative of the progress through the corresponding procedure. At block 2020, the programmable circuitry 304 determines whether the procedure is completed. If not, the operations 2000 returns to block 2012 to continue the procedure. If the procedure is completed, control advances to block 2022.

At block 2022, the interface circuitry 302 provides notification to the client device 106 of the procedure completion. At block 2024, the interface circuitry 302 provides all recorded procedures values (previously stored in the local memory) to the client device 106 to refresh and/or update the trend graph if the down sampled set of data was previously provided. If the substantially real-time data was not down sampled, block 2024 may be omitted. Thereafter, control advances to block 2026, at which the programmable circuitry 304 determines whether to continue the process. If so, control returns to block 2006. Otherwise, the example operations 2000 of FIG. 20 end.

FIG. 21 is a block diagram of an example programmable circuitry platform 2100 structured to execute and/or instantiate the example machine-readable instructions and/or the example operations of FIGS. 19 and 20 to implement the digital valve controller 102 of FIG. 3. The programmable circuitry platform 2100 can be, for example, a server, a personal computer, a workstation, a self-learning machine (e.g., a neural network), an embedded system, or any other type of computing and/or electronic device.

The programmable circuitry platform 2100 of the illustrated example includes programmable circuitry 2112. The programmable circuitry 2112 of the illustrated example is hardware. For example, the programmable circuitry 2112 can be implemented by one or more integrated circuits, logic circuits, FPGAs, microprocessors, CPUs, GPUs, DSPs, XPUs, and/or microcontrollers from any desired family or manufacturer. The programmable circuitry 2112 may be implemented by one or more semiconductor based (e.g., silicon based) devices. In this example, the programmable circuitry 2112 implements the programmable circuitry 304 and the GUI 308.

The programmable circuitry 2112 of the illustrated example includes a local memory 2113 (e.g., a cache, registers, etc.). The programmable circuitry 2112 of the illustrated example is in communication with main memory 2114, 2116, which includes a volatile memory 2114 and a non-volatile memory 2116, by a bus 2118. The volatile memory 2114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2116 may be implemented by flash memory and/or any other desired type of memory device. Access to the main memory 2114, 2116 of the illustrated example is controlled by a memory controller 2117. In some examples, the memory controller 2117 may be implemented by one or more integrated circuits, logic circuits, microcontrollers from any desired family or manufacturer, or any other type of circuitry to manage the flow of data going to and from the main memory 2114, 2116. In examples disclosed herein, the main memory 2114, 2116 is part of the memory system 306 of FIG. 3.

The programmable circuitry platform 2100 of the illustrated example also includes interface circuitry 2120. The interface circuitry 2120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In examples disclosed herein, the interface circuitry 2120 implements the interface circuitry 302 of FIG. 3.

In the illustrated example, one or more input devices 2122 are connected to the interface circuitry 2120. The input device(s) 2122 permit(s) a user (e.g., a human user, a machine user, etc.) to enter data and/or commands into the programmable circuitry 2112. The input device(s) 2122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 2124 are also connected to the interface circuitry 2120 of the illustrated example. The output device(s) 2124 can be implemented, for example, by display devices (e.g., a light emitting diode (LED), an organic light emitting diode (OLED), a liquid crystal display (LCD), an in-place switching (IPS) display, a touchscreen, etc.), and/or a tactile output device. The interface circuitry 2120 of the illustrated example, thus, typically includes a graphics driver card, a graphics driver chip, and/or graphics processor circuitry such as a GPU.

The interface circuitry 2120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 2100 of the illustrated example also includes one or more mass storage discs or devices 2128 to store firmware, software, and/or data. Examples of such mass storage discs or devices 2128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In examples disclosed herein, the mass storage discs or devices 2128 are part of the memory system 306 of FIG. 3.

The machine-readable instructions 2132, which may be implemented by the machine-readable instructions of FIGS. 19 and 20, may be stored in the mass storage device 2128, in the volatile memory 2114, in the non-volatile memory 2116, and/or on at least one non-transitory computer readable storage medium which may be removable.

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

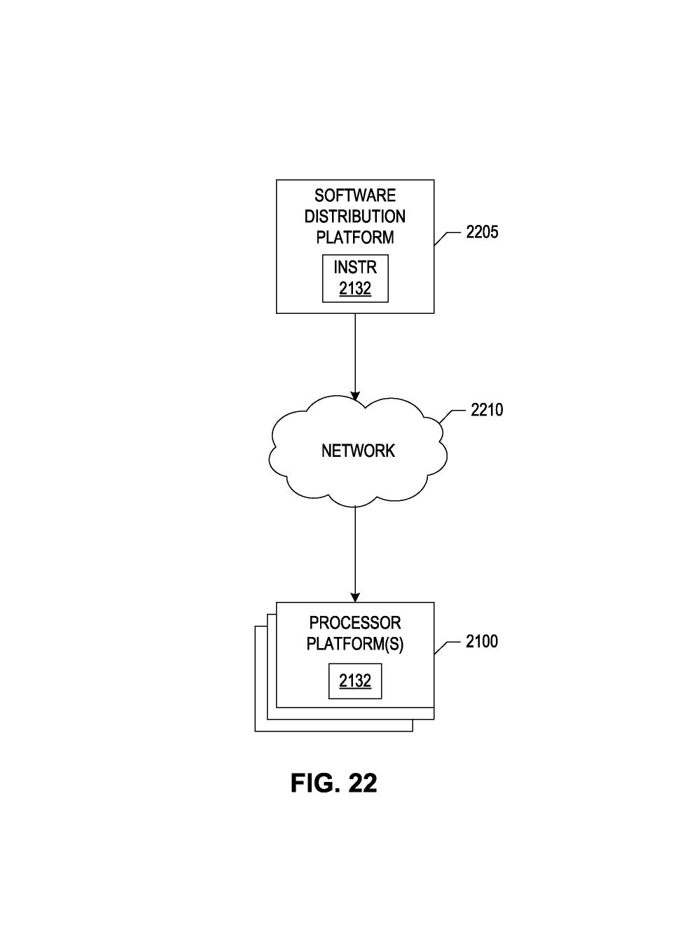

A block diagram illustrating an example software distribution platform 2205 to distribute software such as the example machine-readable instructions 2132 of FIG. 21 to other hardware devices (e.g., hardware devices owned and/or operated by third parties from the owner and/or operator of the software distribution platform) is illustrated in FIG. 22. The example software distribution platform 2205 may be implemented by any computer server, data facility, cloud service, etc., capable of storing and transmitting software to other computing devices. The third parties may be customers of the entity owning and/or operating the software distribution platform 2205. In the illustrated example, the software distribution platform 2205 includes one or more servers and one or more storage devices. The storage devices store the machine-readable instructions 2132, which may correspond to the example machine-readable instructions of FIGS. 19 and 20, as described above. The one or more servers of the example software distribution platform 2205 are in communication with an example network 2210, which may correspond to any one or more of the Internet and/or any of the example networks described above. The servers enable downloading the machine-readable instructions 2132 from the software distribution platform 2205. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

As used herein “substantially real time” and “substantially real-time” refer to occurrence in a near instantaneous manner recognizing there may be real world delays for computing time, transmission, etc. Thus, unless otherwise specified, “substantially real time” and “substantially real-time” refer to real time + 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs), one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

From the foregoing, it will be appreciated that example systems, apparatus, articles of manufacture, and methods have been disclosed to implement digital field device controllers with webservers. Disclosed systems, apparatus, articles of manufacture, and methods improve the efficiency of interacting with a field device controller in a process control system by implementing a webserver in the field device controller to provide device-specific data through a streamlined, browser-accessible interface on a client device. Disclosed systems, apparatus, articles of manufacture, and methods are accordingly directed to one or more improvement(s) in the operation of a machine such as a computer or other electronic and/or mechanical device.

Further examples and combinations thereof include the following:

Example 1 includes an apparatus comprising interface circuitry, machine-readable instructions, programmable circuitry to be programmed by the machine-readable instructions to instantiate a webserver at a field device in a control system, establish a connection between the webserver and a client device, cause the field device to perform a procedure, collect data associated with performance of the procedure, and cause the interface circuitry to transmit the data from the webserver to the client device in substantially real-time to when the data is collected.

Example 2 includes the apparatus of any preceding clause, wherein the procedure includes updating a calibration of the field device based on a calibration request from the client device.

Example 3 includes the apparatus of any preceding clause, wherein the field device is a digital valve controller, and the data represents movement of a fluid control valve.

Example 4 includes the apparatus of any preceding clause, wherein the procedure includes a step test for the fluid control valve.

Example 5 includes the apparatus of any preceding clause, wherein the procedure includes a valve signature procedure for the fluid control valve.

Example 6 includes the apparatus of any preceding clause, wherein the data transmitted to the client device is down sampled relative to a full amount of the data collected during the performance of the procedure.

Example 7 includes the apparatus of any preceding clause, wherein the programmable circuitry is to update a display of the data provided to the client device to include the full amount of the data once the procedure is completed.

Example 8 includes a non-transitory machine-readable medium comprising instructions to cause programmable circuitry to at least interface circuitry, machine-readable instructions, programmable circuitry to be programmed by the machine-readable instructions to instantiate a webserver at a field device in a control system, establish a connection between the webserver and a client device, cause the field device to perform a procedure, collect data associated with performance of the procedure, and cause transmission of the data from the webserver to the client device in substantially real-time to when the data is collected.

Example 9 includes the non-transitory machine-readable medium of any preceding clause, wherein the procedure includes updating a calibration of the field device based on a calibration request from the client device.

Example 10 includes the non-transitory machine-readable medium of any preceding clause, wherein the field device is a digital valve controller, and the data represents movement of a fluid control valve.

Example 11 includes the non-transitory machine-readable medium of any preceding clause, wherein the procedure includes a step test for the fluid control valve.

Example 12 includes the non-transitory machine-readable medium of any preceding clause, wherein the procedure includes a valve signature procedure for the fluid control valve.

Example 13 includes the non-transitory machine-readable medium of any preceding clause, wherein the data transmitted to the client device is down sampled relative to a full amount of the data collected during the performance of the procedure.

Example 14 includes the non-transitory machine-readable medium of any preceding clause, wherein the instructions are to cause the programmable circuitry to update a display of the data provided to the client device to include the full amount of the data once the procedure is completed.

Example 15 includes a method comprising instantiating, by executing instructions with programmable circuitry, a webserver at a field device in a control system, establishing a connection between the webserver and a client device, causing the field device to perform a procedure, collecting data associated with performance of the procedure, and transmitting, by executing instructions with programmable circuitry, the data from the webserver to the client device in substantially real-time to when the data is collected.

Example 16 includes the method of any preceding clause, wherein the procedure includes updating a calibration of the field device based on a calibration request from the client device.

Example 17 includes the method of any preceding clause, wherein the field device is a digital valve controller, and the data represents movement of a fluid control valve.

Example 18 includes the method of any preceding clause, wherein the procedure includes a step test for the fluid control valve.

Example 19 includes the method of any preceding clause, wherein the procedure includes a valve signature procedure for the fluid control valve.

Example 20 includes the method of any preceding clause, wherein the data transmitted to the client device is down sampled relative to a full amount of the data collected during the performance of the procedure.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions;
programmable circuitry to be programmed by the machine-readable instructions to:
instantiate a webserver at a field device in a control system;
establish a connection between the webserver and a client device;
cause the field device to perform a procedure;
collect data associated with performance of the procedure; and
cause the interface circuitry to transmit the data from the webserver to the client device in substantially real-time to when the data is collected.

2. The apparatus of claim 1, wherein the procedure includes updating a calibration of the field device based on a calibration request from the client device.

3. The apparatus of claim 1, wherein the field device is a digital valve controller, and the data represents movement of a fluid control valve.

4. The apparatus of claim 3, wherein the procedure includes a step test for the fluid control valve.

5. The apparatus of claim 3, wherein the procedure includes a valve signature procedure for the fluid control valve.

6. The apparatus of claim 1, wherein the data transmitted to the client device is down sampled relative to a full amount of the data collected during the performance of the procedure.

7. The apparatus of claim 6, wherein the programmable circuitry is to update a display of the data provided to the client device to include the full amount of the data once the procedure is completed.

8. A non-transitory machine-readable medium comprising instructions to cause programmable circuitry to at least:
interface circuitry;
machine-readable instructions;
programmable circuitry to be programmed by the machine-readable instructions to:
instantiate a webserver at a field device in a control system;
establish a connection between the webserver and a client device;
cause the field device to perform a procedure;
collect data associated with performance of the procedure; and
cause transmission of the data from the webserver to the client device in substantially real-time to when the data is collected.

9. The non-transitory machine-readable medium of claim 8, wherein the procedure includes updating a calibration of the field device based on a calibration request from the client device.

10. The non-transitory machine-readable medium of claim 8, wherein the field device is a digital valve controller, and the data represents movement of a fluid control valve.

11. The non-transitory machine-readable medium of claim 10, wherein the procedure includes a step test for the fluid control valve.

12. The non-transitory machine-readable medium of claim 10, wherein the procedure includes a valve signature procedure for the fluid control valve.

13. The non-transitory machine-readable medium of claim 8, wherein the data transmitted to the client device is down sampled relative to a full amount of the data collected during the performance of the procedure.

14. The non-transitory machine-readable medium of claim 13, wherein the instructions are to cause the programmable circuitry to update a display of the data provided to the client device to include the full amount of the data once the procedure is completed.

15. A method comprising:
instantiating, by executing instructions with programmable circuitry, a webserver at a field device in a control system;
establishing a connection between the webserver and a client device;
causing the field device to perform a procedure;
collecting data associated with performance of the procedure; and
transmitting, by executing instructions with programmable circuitry, the data from the webserver to the client device in substantially real-time to when the data is collected.

16. The method of claim 15, wherein the procedure includes updating a calibration of the field device based on a calibration request from the client device.

17. The method of claim 15, wherein the field device is a digital valve controller, and the data represents movement of a fluid control valve.

18. The method of claim 17, wherein the procedure includes a step test for the fluid control valve.

19. The method of claim 17, wherein the procedure includes a valve signature procedure for the fluid control valve.

20. The method of claim 15, wherein the data transmitted to the client device is down sampled relative to a full amount of the data collected during the performance of the procedure.
